(19) United States
(12) Patent Application Publication
(10) Pub. No.: US 2019/0147320 A1
(43) Pub. Date: May 16, 2019

(54) "Matching Adversarial Networks"

(71) Applicant: Uber Technologies, Inc., San Francisco, CA (US)

(72) Inventors: Gellert Sandor Mattyus, Toronto (CA); Raquel Urtasun Sotil, Toronto (CA)

(21) Appl. No.: 16/191,735

(22) Filed: Nov. 15, 2018

Related U.S. Application Data
(60) Provisional application No. 62/586,818, filed on Nov. 15, 2017.

(51) Int. Cl. G06N 3/04; G06N 3/08; G06K 9/62; G06K 9/00

(52) U.S. Cl. CPC G06N 3/0454; G06N 3/08; G06K 9/00651; G06K 9/6259; G06N 3/0481

(57) ABSTRACT

A method includes obtaining training data including one or more images and one or more ground truth labels of the one or more images, and training an adversarial network including a siamese discriminator network and a generator network. The training includes generating, with the generator network, one or more generated images based on the one or more images; processing, with the siamese discriminator network, at least one pair of images to determine a prediction of whether the at least one pair of images includes the one or more generated images; and modifying, using a loss function of the adversarial network that depends on the ground truth label and the prediction, one or more parameters of the generator network.

### CROSS REFERENCE TO RELATED APPLICATIONS

This application claims the benefit of U.S. Provisional Application No. 62/586,818 filed Nov. 15, 2017, the entire disclosure of which is hereby incorporated by reference in its entirety.

### BACKGROUND

An autonomous vehicle (e.g., a driverless car, a driverless automobile, a self-driving car, a robotic car, etc.) is a vehicle that is capable of sensing an environment of the vehicle and traveling (e.g., navigating, moving, etc.) in the environment without human input. An autonomous vehicle uses a variety of techniques to detect the environment of the autonomous vehicle, such as radar, laser light, Global Positioning System (GPS), odometry, and/or computer vision. In some instances, an autonomous vehicle uses a control system to interpret information received from one or more sensors, to identify a route for traveling, to identify an obstacle in a route, and to identify relevant traffic signs associated with a route.

A Generative Adversarial Network (GAN) provides an ability to generate sharp, realistic images. A GAN can be used to train deep generative models using a minimax game. For example, a GAN may be used to teach a generator (e.g., a network that generates examples) by fooling a discriminator (e.g., a network that evaluates examples), which tries to distinguish between real examples and generated examples.

A Conditional GAN (CGAN) is an extension of a GAN. A CGAN can be used to model conditional distributions by making the generator and the discriminator a function of the input (e.g., what is conditioned on). Although CGANs may perform well at image generation tasks (e.g., synthesizing highly structured outputs, such as natural images, and/or the like, etc.), CGANs may not perform well on common supervised tasks (e.g., semantic segmentation, instance segmentation, line detection, etc.) with well-defined metrics, because the generator is optimized by minimizing a loss function that does not depend on the training examples (e.g., the discriminator network is applied as a universal loss function for common supervised tasks, etc.). Existing attempts to tackle this issue define and add a task dependent loss function to the objective. Unfortunately, it is very difficult to balance the two loss functions resulting in unstable and often poor training.

### SUMMARY

Accordingly, provided are improved systems, devices, products, apparatus, and/or methods for training, providing, and/or using an adversarial network.

According to some non-limiting embodiments or aspects, provided is a computer-implemented method comprising: obtaining, with a computing system comprising one or more processors, training data including one or more images and one or more ground truth labels of the one or more images; and training, with the computing system, an adversarial network including a siamese discriminator network and a generator network by: generating, with the generator network, one or more generated images based on the one or more images; processing, with the siamese discriminator network, at least one pair of images including: (i) a ground truth label of the one or more ground truth labels of the one or more images; and (ii) one of: (a) a generated image of the one or more generated images generated by the generator network; and (b) a perturbed image of the ground truth label of the one or more ground truth labels of the one or more images, to determine a prediction of whether the at least one pair of images includes the one or more generated images; and modifying, using a loss function of the adversarial network that depends on the ground truth label and the prediction, one or more parameters of the generator network.

In some non-limiting embodiments or aspects, training, with the computing system, the adversarial network comprises: modifying, using the loss function of the adversarial network that depends on the ground truth label and the prediction, one or more parameters of the siamese discriminator network.

In some non-limiting embodiments or aspects, training, with the computing system, the adversarial network comprises: iteratively alternating between (i) modifying the one or more parameters of the generator network to optimize the loss function of the adversarial network with respect to the one or more parameters of the generator network and (ii) modifying the one or more parameters of the siamese discriminator network to optimize the loss function of the adversarial network with respect to the one or more parameters of the siamese discriminator network.

In some non-limiting embodiments or aspects, applying, with the computing system, a perturbation to the generated image of the one or more generated images generated by the generator network.

In some non-limiting embodiments or aspects, processing, with the siamese discriminator network, the at least one pair of images comprises: receiving, with a first branch of the siamese discriminator network, as a first siamese input the ground truth label of the one or more ground truth labels of the one or more images; receiving, with a second branch of the siamese discriminator network, as a second siamese input the one of: (a) the generated image of the one or more generated images generated by the generator network; and (b) the perturbed image of the ground truth label of the one or more ground truth labels of the one or more images; applying, with the first branch of the siamese discriminator network, a first complex multi-layer non-linear transformation to the first siamese input to map the first siamese input to a first feature vector; applying, with the second branch of the siamese discriminator network, a second complex multi-layer non-linear transformation to the second siamese input to map the second siamese input to a second feature vector; and combining the first feature vector and the second feature vector in a combined feature vector, the prediction of whether the at least one pair of images includes the one or more generated images being determined based on the combined feature vector.

In some non-limiting embodiments or aspects, the method further comprises: providing, with the computing system, the generator network including the one or more parameters that have been modified based on the loss function of the adversarial network that depends on the ground truth label and the prediction; obtaining, with the computing system, input data including one or more other images; and processing, with the computing system and using the generator network, the input data to generate output data.

In some non-limiting embodiments or aspects, the one or more other images include an image of a geographic region having a roadway, and the output data includes feature data representing an extracted centerline of the roadway.

In some non-limiting embodiments or aspects, the one or more other images include an image having one or more objects, and the output data includes classification data representing a classification of each of the one or more objects within a plurality of predetermined classifications.

In some non-limiting embodiments or aspects, the one or more other images include an image having one or more objects, and the output data includes identification data representing an identification of the one or more objects.

In some non-limiting embodiments or aspects, the computing system is on-board an autonomous vehicle.

According to some non-limiting embodiments or aspects, provided is a computing system comprising: one or more processors programmed and/or configured to: obtain training data including one or more images and one or more ground truth labels of the one or more images; and train an adversarial network including a siamese discriminator network and a generator network by: generating, with the generator network, one or more generated images based on the one or more images; processing, with the siamese discriminator network, at least one pair of images including: (i) a ground truth label of the one or more ground truth labels of the one or more images; and (ii) one of: (a) a generated image of the one or more generated images generated by the generator network; and (b) a perturbed image of the ground truth label of the one or more ground truth labels of the one or more images, to determine a prediction of whether the at least one pair of images includes the one or more generated images; and modifying, using a loss function of the adversarial network that depends on the ground truth label and the prediction, one or more parameters of the generator network.

In some non-limiting embodiments or aspects, the one or more processors are programmed and/or configured to train the adversarial network by: modifying, using the loss function of the adversarial network that depends on the ground truth label and the prediction, one or more parameters of the siamese discriminator network.

In some non-limiting embodiments or aspects, the one or more processors are programmed and/or configured to train the adversarial network by: iteratively alternating between (i) modifying the one or more parameters of the generator network to optimize the loss function of the adversarial network with respect to the one or more parameters of the generator network; and (ii) modifying the one or more parameters of the siamese discriminator network to optimize the loss function of the adversarial network with respect to the one or more parameters of the siamese discriminator network.

In some non-limiting embodiments or aspects, the one or more processors are further programmed and/or configured to: apply a perturbation to the generated image of the one or more generated images generated by the generator network.

In some non-limiting embodiments or aspects, processing, with the siamese discriminator network, the at least one pair of images comprises: receiving, with a first branch of the siamese discriminator network, as a first siamese input the ground truth label of the one or more ground truth labels of the one or more images; receiving, with a second branch of the siamese discriminator network, as a second siamese input the one of: (a) the generated image of the one or more generated images generated by the generator network; and (b) the perturbed image of the ground truth label of the one or more ground truth labels of the one or more images; applying, with the first branch of the siamese discriminator network, a first complex multi-layer non-linear transformation to the first siamese input to map the first siamese input to a first feature vector; applying, with the second branch of the siamese discriminator network, a second complex multi-layer non-linear transformation to the second siamese input to map the second siamese input to a second feature vector; and combining the first feature vector and the second feature vector in a combined feature vector, the prediction of whether the at least one pair of images includes the one or more generated images being determined based on the combined feature vector.

In some non-limiting embodiments or aspects, the one or more processors are further programmed and/or configured to: provide the generator network including the one or more parameters that have been modified based on the loss function of the adversarial network that depends on the ground truth label and the prediction; obtain input data including one or more other images; and process, using the generator network, the input data to generate output data.

In some non-limiting embodiments or aspects, the one or more other images include an image of a geographic region having a roadway, and the output data includes feature data representing an extracted centerline of the roadway.

In some non-limiting embodiments or aspects, the one or more other images include an image having one or more objects, and the output data includes classification data representing a classification of each of the one or more objects within a plurality of predetermined classifications.

In some non-limiting embodiments or aspects, the one or more other images include an image having one or more objects, and the output data includes identification data representing an identification of the one or more objects.

In some non-limiting embodiments or aspects, the one or more processors are on-board an autonomous vehicle.

According to some non-limiting embodiments or aspects, provided is a computer program product comprising at least one non-transitory computer-readable medium including program instructions that, when executed by at least one processor, cause the at least one processor to: obtain training data including one or more images and one or more ground truth labels of the one or more images; and train an adversarial network including a siamese discriminator network and a generator network by: generating, with the generator network, one or more generated images based on the one or more images; processing, with the siamese discriminator network, at least one pair of images including: (i) a ground truth label of the one or more ground truth labels of the one or more images; and (ii) one of: (a) a generated image of the one or more generated images generated by the generator network; and (b) a perturbed image of the ground truth label of the one or more ground truth labels of the one or more images, to determine a prediction of whether the at least one pair of images includes the one or more generated images; and modifying, using a loss function of the adversarial network that depends on the ground truth label and the prediction, one or more parameters of the generator network.

According to some non-limiting embodiments or aspects, provided is an autonomous vehicle comprising a vehicle computing system that comprises one or more processors, wherein the vehicle computing system is configured to: obtain training data including one or more images and one or more ground truth labels of the one or more images; and train an adversarial network including a siamese discriminator network and a generator network by: generating, with the generator network, one or more generated images based on the one or more images; processing, with the siamese discriminator network, at least one pair of images including: (i) a ground truth label of the one or more ground truth labels of the one or more images; and (ii) one of: (a) a generated image of the one or more generated images generated by the generator network; and (b) a perturbed image of the ground truth label of the one or more ground truth labels of the one or more images, to determine a prediction of whether the at least one pair of images includes the one or more generated images; and modifying, using a loss function of the adversarial network that depends on the ground truth label and the prediction, one or more parameters of the generator network.

According to some non-limiting embodiments or aspects, provided is an autonomous vehicle comprising a vehicle computing system that comprises one or more processors, wherein the vehicle computing system is configured to: process, with a generator network of an adversarial network having a loss function implemented based on a siamese discriminator network, image data to determine output data; and control travel of the autonomous vehicle on a route based on the output data.

Further non-limiting embodiments or aspects are set forth in the following numbered clauses:

Clause 1. A computer-implemented method comprising: obtaining, with a computing system comprising one or more processors, training data including one or more images and one or more ground truth labels of the one or more images; and training, with the computing system, an adversarial network including a siamese discriminator network and a generator network by: generating, with the generator network, one or more generated images based on the one or more images; processing, with the siamese discriminator network, at least one pair of images including: (i) a ground truth label of the one or more ground truth labels of the one or more images; and (ii) one of: (a) a generated image of the one or more generated images generated by the generator network; and (b) a perturbed image of the ground truth label of the one or more ground truth labels of the one or more images, to determine a prediction of whether the at least one pair of images includes the one or more generated images; and modifying, using a loss function of the adversarial network that depends on the ground truth label and the prediction, one or more parameters of the generator network.

Clause 2. The computer-implemented method of clause 1, wherein training, with the computing system, the adversarial network comprises: modifying, using the loss function of the adversarial network that depends on the ground truth label and the prediction, one or more parameters of the siamese discriminator network.

Clause 3. The computer-implemented method of any of clauses 1 and 2, wherein training, with the computing system, the adversarial network comprises: iteratively alternating between: (i) modifying the one or more parameters of the generator network to optimize the loss function of the adversarial network with respect to the one or more parameters of the generator network; and (ii) modifying the one or more parameters of the siamese discriminator network to optimize the loss function of the adversarial network with respect to the one or more parameters of the siamese discriminator network.

Clause 4. The computer-implemented method of any of clauses 1-3, further comprising: applying, with the computing system, a perturbation to the generated image of the one or more generated images generated by the generator network.

Clause 5. The computer-implemented method of any of clauses 1-4, wherein processing, with the siamese discriminator network, the at least one pair of images comprises: receiving, with a first branch of the siamese discriminator network, as a first siamese input the ground truth label of the one or more ground truth labels of the one or more images; receiving, with a second branch of the siamese discriminator network, as a second siamese input the one of: (a) the generated image of the one or more generated images generated by the generator network; and (b) the perturbed image of the ground truth label of the one or more ground truth labels of the one or more images; applying, with the first branch of the siamese discriminator network, a first complex multi-layer non-linear transformation to the first siamese input to map the first siamese input to a first feature vector; applying, with the second branch of the siamese discriminator network, a second complex multi-layer non-linear transformation to the second siamese input to map the second siamese input to a second feature vector; and combining the first feature vector and the second feature vector in a combined feature vector, wherein the prediction of whether the at least one pair of images includes the one or more generated images is determined based on the combined feature vector.

Clause 6. The computer-implemented method of any of clauses 1-5, further comprising: providing, with the computing system, the generator network including the one or more parameters that have been modified based on the loss function of the adversarial network that depends on the ground truth label and the prediction; obtaining, with the computing system, input data including one or more other images; and processing, with the computing system and using the generator network, the input data to generate output data.

Clause 7. The computer-implemented method of any of clauses 1-6, wherein the one or more other images include an image of a geographic region having a roadway, and wherein the output data includes feature data representing an extracted centerline of the roadway.

Clause 8. The computer-implemented method of any of clauses 1-7, wherein the one or more other images include an image having one or more objects, and wherein the output data includes classification data representing a classification of each of the one or more objects within a plurality of predetermined classifications.

Clause 9. The computer-implemented method of any of clauses 1-8, wherein the one or more other images include an image having one or more objects, and wherein the output data includes identification data representing an identification of the one or more objects.

Clause 10. The computer-implemented method of any of clauses 1-9, wherein the computing system is on-board an autonomous vehicle.

Clause 11. A computing system comprising: one or more processors programmed and/or configured to: obtain training data including one or more images and one or more ground truth labels of the one or more images; and train an adversarial network including a siamese discriminator network and a generator network by: generating, with the generator network, one or more generated images based on the one or more images; processing, with the siamese discriminator network, at least one pair of images including: (i) a ground truth label of the one or more ground truth labels of the one or more images; and (ii) one of: (a) a generated image of the one or more generated images generated by the generator network; and (b) a perturbed image of the ground truth label of the one or more ground truth labels of the one or more images, to determine a prediction of whether the at least one pair of images includes the one or more generated images; and modifying, using a loss function of the adversarial network that depends on the ground truth label and the prediction, one or more parameters of the generator network.

Clause 12. The computing system of clause 11, wherein the one or more processors are programmed and/or configured to train the adversarial network by: modifying, using the loss function of the adversarial network that depends on the ground truth label and the prediction, one or more parameters of the siamese discriminator network.

Clause 13. The computing system of any of clauses 11 and 12, wherein the one or more processors are programmed and/or configured to train the adversarial network by: iteratively alternating between: (i) modifying the one or more parameters of the generator network to optimize the loss function of the adversarial network with respect to the one or more parameters of the generator network; and (ii) modifying the one or more parameters of the siamese discriminator network to optimize the loss function of the adversarial network with respect to the one or more parameters of the siamese discriminator network.

Clause 14. The computing system of any of clauses 11-13, wherein the one or more processors are further programmed and/or configured to: apply a perturbation to the generated image of the one or more generated images generated by the generator network.

Clause 15. The computing system of any of clauses 11-14, wherein processing, with the siamese discriminator network, the at least one pair of images comprises: receiving, with a first branch of the siamese discriminator network, as a first siamese input the ground truth label of the one or more ground truth labels of the one or more images; receiving, with a second branch of the siamese discriminator network, as a second siamese input the one of: (a) the generated image of the one or more generated images generated by the generator network; and (b) the perturbed image of the ground truth label of the one or more ground truth labels of the one or more images; applying, with the first branch of the siamese discriminator network, a first complex multi-layer non-linear transformation to the first siamese input to map the first siamese input to a first feature vector; applying, with the second branch of the siamese discriminator network, a second complex multi-layer non-linear transformation to the second siamese input to map the second siamese input to a second feature vector; and combining the first feature vector and the second feature vector in a combined feature vector, wherein the prediction of whether the at least one pair of images includes the one or more generated images is determined based on the combined feature vector.

Clause 16. The computing system of any of clauses 11-15, wherein the one or more processors are further programmed and/or configured to: provide the generator network including the one or more parameters that have been modified based on the loss function of the adversarial network that depends on the ground truth label and the prediction; obtain input data including one or more other images; and process, using the generator network, the input data to generate output data.

Clause 17. The computing system of any of clauses 11-16, wherein the one or more other images include an image of a geographic region having a roadway, and wherein the output data includes feature data representing an extracted centerline of the roadway.

Clause 18. The computing system of any of clauses 11-17, wherein the one or more other images include an image having one or more objects, and wherein the output data includes classification data representing a classification of each of the one or more objects within a plurality of predetermined classifications.

Clause 19. The computing system of any of clauses 11-18, wherein the one or more other images include an image having one or more objects, and wherein the output data includes identification data representing an identification of the one or more objects.

Clause 20. The computing system of any of clauses 11-19, wherein the one or more processors are on-board an autonomous vehicle.

### BRIEF DESCRIPTION OF THE DRAWINGS

FIG. 1 is a diagram of a non-limiting embodiment or aspect of an environment in which systems, devices, products, apparatus, and/or methods, described herein, can be implemented;

FIG. 2 is a diagram of a non-limiting embodiment or aspect of a system for controlling an autonomous vehicle shown in FIG. 1;

FIG. 3 is a diagram of a non-limiting embodiment or aspect of components of one or more devices and/or one or more systems of FIGS. 1 and 2;

FIG. 4 is a flowchart of a non-limiting embodiment or aspect of a process for training, providing, and/or using an adversarial network;

FIGS. 5A and 5B are diagrams of a non-limiting embodiment or aspect of a matching adversarial network (MatAN) that receives as input a positive sample and a negative sample, respectively;

FIGS. 6A-6C are diagrams of a non-limiting embodiment or aspect of an example input image, a ground truth of the example input image, and a perturbation of the ground truth of the example input image, respectively;

FIGS. 7A-7E are graphs of joint probability distributions for non-limiting embodiments or aspects of implementations of perturbation configurations for a MatAN;

FIG. 8 is a diagram of example outputs of implementations of semantic segmentation processes disclosed herein;

FIG. 9 is a diagram of example outputs of implementations of semantic segmentation processes disclosed herein;

FIG. 10 is a diagram of example outputs of implementations of road centerline extraction processes disclosed herein; and

FIG. 11 is a diagram of example outputs of implementations of instance segmentation processes disclosed herein.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to embodiments or aspects as they are oriented in the drawing figures. However, it is to be understood that embodiments or aspects may assume various alternative variations and step sequences, except where expressly specified to the contrary. It is also to be understood that the specific devices and processes illustrated in the attached drawings, and described in the following specification, are simply non-limiting exemplary embodiments or aspects. Hence, specific dimensions and other physical characteristics related to the embodiments or aspects of the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. A computing device may be a mobile or portable computing device, a desktop computer, a server, and/or the like. Furthermore, the term “computer” may refer to any computing device that includes the necessary components to receive, process, and output data, and normally includes a display, a processor, a memory, an input device, and a network interface. A “computing system” may include one or more computing devices or computers. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.). Further, multiple computers, e.g., servers, or other computerized devices, such as an autonomous vehicle including a vehicle computing system, directly or indirectly communicating in the network environment may constitute a “system” or a “computing system”.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Provided are improved systems, devices, products, apparatus, and/or methods for training, providing, and/or using an adversarial network. A Generative Adversarial Network (GAN) can train deep generative models using a minimax game. To generate samples or examples for training, a generator network maps a random noise vector z into a high dimensional output y (e.g., an image, etc.) via a neural network y=G(z, θ_{G}). The generator network G is trained to fool a discriminator network, D(y, θ_{D}), which tries to discriminate between generated samples (e.g., negative samples, etc.) and real samples (e.g., positive samples, etc.). The GAN minimax game can be written as the following Equation (1):

$${min}_{{Θ}_{G}} {max}_{{Θ}_{D}} {ℒ}_{GAN} ( \hat{y} , z , {Θ}_{D} , {Θ}_{G} ) = {𝔼}_{\hat{y} \sim {p}_{y}} log ( D ( \hat{y} , {Θ}_{D} ) ) + {𝔼}_{z \sim p ( z )} log ( 1 - D ( G ( z , {Θ}_{G} ) , {Θ}_{D} ) \qquad ( 1 )$$

In Equation (1), the first term E_{ŷ˜p(z)}log(D(ŷ, θ_{D})) sums over the positive samples (e.g., positive training examples, etc.) for the discriminator network, and the second term E_{ŷ˜p(z)}g(1-D(G(z, θ_{G}), θ_{D}) sums over the negative samples (e.g., negative training examples, etc.), which are generated by the generator network by sampling from the noise prior. Learning in a GAN is an iterative process which alternates between optimizing the loss L_{GAN}(ŷ, z, θD, θG) with respect to the discriminator parameters θ_{D} of the discriminator network D(y, θ_{D}) and the generator parameters θ_{G} of the generator network G(z, θ_{G}), respectively. The discriminator network estimates the ratio of the data distribution p_{d}(y) and the generated distribution p_{g}(y): D*_{G} (y)=p_{d}(y)/(p_{d}(y)+p_{g}(y)). A global minimum of the training criterion (e.g., an equilibrium, etc.) is where the two probability distributions are identical (e.g., p_{g}=p_{d}, D*_{G} (y)=½). In some cases, a global minimum may be provided. However, the gradients with respect to θ_{G} do not depend on ŷ directly, but only implicitly through the current estimate of θ_{D}. In this way, the generator network G(z, θ_{G}) can produce any samples from the data distribution, which prevents learning of input-output relations that may be otherwise included in supervised training.

A GAN can be extended to a conditional GAN (CGAN) by introducing dependency of the generator network and the discriminator network on an input x. For example, the discriminator network for the positive samples can be D(x, ŷ, θ_{D}), and the discriminator network for the negative samples can be D(x, G(x, θ_{G}, z), θ_{D}). Because D(x, G(x, z, θ_{G}), θ_{D}) does not depend on the training targets (e.g., training of the generator network consists of optimizing a loss function that does not depend directly on the positive samples or ground truth labels, etc.), an additional discriminative loss function may be added to the objective (e.g., a pixel-wise l₁ norm). However, a simple linear combination may not work well to balance the influence of the adversarial and task losses, and adding an adversarial loss to a task-specific loss may not improve performance of the CGAN. In this way, existing computer systems and adversarial networks have no mechanism for optimizing a loss function that depends directly on ground truth labels. Accordingly, existing computer systems and adversarial networks may not perform well on common supervised tasks (e.g., semantic segmentation, instance segmentation, line detection, etc.) with well-defined metrics.

Non-limiting embodiments or aspects of the present disclosure are directed to systems, devices, products, apparatus, and/or methods for training, providing, and/or using an adversarial network including a siamese discriminator network and a generator network. For example, a discriminator network of an adversarial network is replaced with a siamese discriminator network (e.g., with a matching network that takes into account each of: (i) ground truth outputs or positive samples; and (ii) generated samples or negative samples, etc.). As an example, a method may include obtaining training data including one or more images and one or more ground truth labels of the one or more images; and training an adversarial network including a siamese discriminator network and a generator network by: generating, with the generator network, one or more generated images based on the one or more images; processing, with the siamese discriminator network, at least one pair of images including: (i) a ground truth label of the one or more ground truth labels of the one or more images; and (ii) one of: (a) a generated image of the one or more generated images generated by the generator network; and (b) a perturbed image of the ground truth label of the one or more ground truth labels of the one or more images, to determine a prediction of whether the at least one pair of images includes the one or more generated images; and modifying, using a loss function of the adversarial network that depends on the ground truth label and the prediction, one or more parameters of the generator network. In such an example, the adversarial network may be referred to as a matching adversarial network (MatAN).

In this way, a loss function of the generator network can depend directly on the training targets, which can provide for: (a) better, faster, more stable (e.g., the MatAN may not result in degenerative output with different generator and discriminator architectures, which is an advantage over an existing CGAN which may be sensitive to applied network architectures, etc.), and/or more robust training or learning; (b) improved performance and/or results for task specific solutions, such as in tasks of semantic segmentation, road network centerline extraction from images, instance segmentation, and/or the like, which outperforms an existing CGAN and/or existing supervised approaches that exploit task-specific solutions; (c) avoiding the use of task-specific loss functions, and/or the like. For example, the siamese discriminator network can predict whether an input pair of images contains generated output and a ground truth (e.g., a prediction of a fake, a prediction of a negative sample, etc.) or the ground truth and a perturbation of the ground truth (e.g., a prediction of a real, a prediction of a positive sample, etc.). As an example, applying random perturbations can render the task of the discriminator network more difficult, with a target or objective of the generator network remaining generation of the ground truth. Accordingly, a MatAN according to some non-limiting embodiments or aspects can be used as an improved discriminative model for supervised tasks, and/or the like.

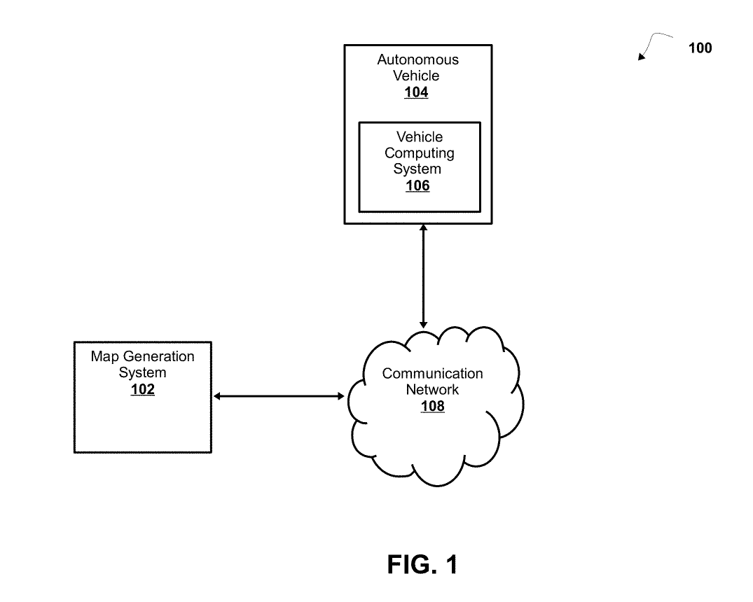

Referring now to FIG. 1, FIG. 1 is a diagram of an example environment 100 in which devices, systems, methods, and/or products described herein, may be implemented. As shown in FIG. 1, environment 100 includes map generation system 102, autonomous vehicle 104 including vehicle computing system 106, and communication network 108. Systems and/or devices of environment 100 can interconnect via wired connections, wireless connections, or a combination of wired and wireless connections.

In some non-limiting embodiments or aspects, map generation system 102 includes one or more devices capable of obtaining training data including one or more images and one or more ground truth labels of the one or more images, training an adversarial network including a siamese discriminator network and a generator network with the training data, providing the generator network from the trained adversarial network, obtaining input data including one or more other images, and/or processing the input data (e.g., performing semantic segmentation, performing road centerline extraction, performing instance segmentation, etc.) to generate output data (e.g., feature data representing an extracted centerline of a roadway, classification data representing a classification of one or more objects within a plurality of predetermined classifications, identification data representing an identification of one or more objects, etc.). For example, map generation system 102 can include one or more computing systems including one or more processors (e.g., one or more servers, etc.).

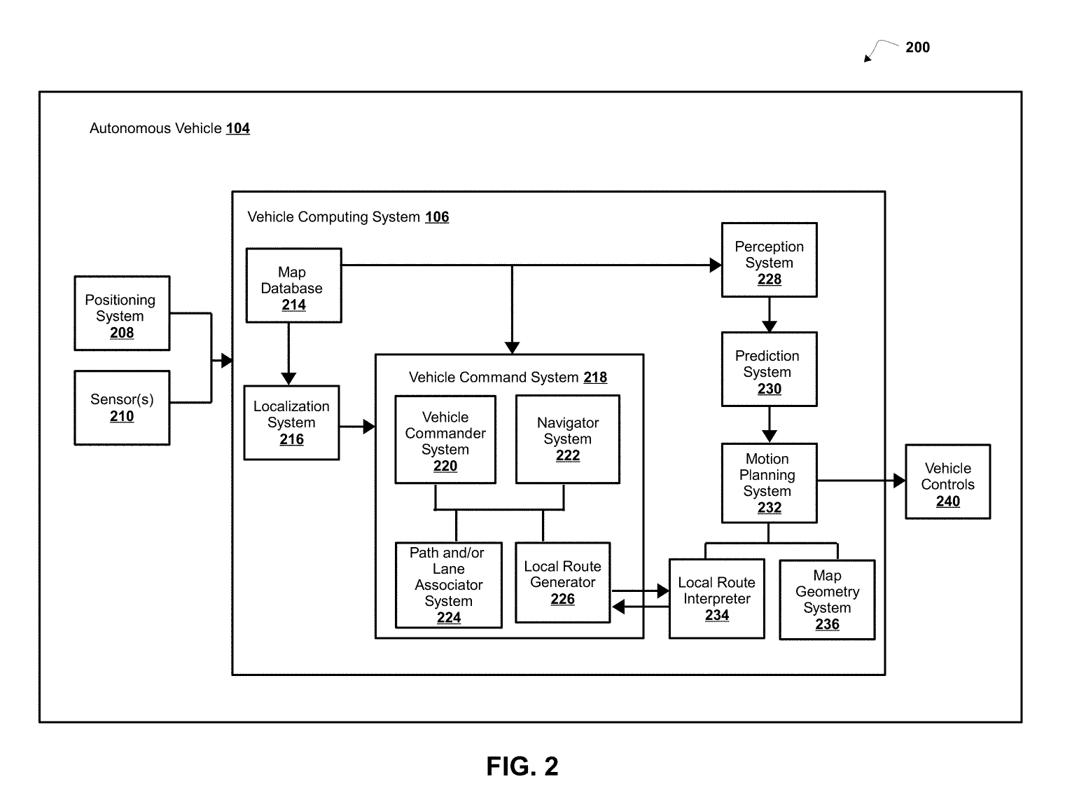

In some non-limiting embodiments or aspects, autonomous vehicle 104 includes one or more devices capable of receiving output data and determining a route in a roadway including a driving path based on the output data. In some non-limiting embodiments or aspects, autonomous vehicle 104 includes one or more devices capable of controlling travel, operation, and/or routing of autonomous vehicle 104 based on output data. For example, the one or more devices may control travel and one or more functionalities associated with a fully autonomous mode of autonomous vehicle 104 on the driving path, based on the output data including feature data or map data associated with the driving path, for example, by controlling the one or more devices (e.g., a device that controls acceleration, a device that controls steering, a device that controls braking, an actuator that controls gas flow, etc.) of autonomous vehicle 104 based on sensor data, position data, and/or output data associated with determining the features associated with the driving path. In some non-limiting embodiments or aspects, autonomous vehicle 104 includes one or more devices capable of obtaining training data including one or more images and one or more ground truth labels of the one or more images, training an adversarial network including a siamese discriminator network and a generator network with the training data, providing the generator network from the trained adversarial network, obtaining input data including one or more other images, and/or processing the input data (e.g., performing semantic segmentation, performing road centerline extraction, and/or performing instance segmentation, etc.) to generate output data (e.g., feature data representing an extracted centerline of a roadway, classification data representing a classification of one or more objects within a plurality of predetermined classifications, identification data representing an identification of one or more objects, etc.). For example, autonomous vehicle 104 can include one or more computing systems including one or more processors (e.g., one or more servers, etc.). Further details regarding non-limiting embodiments of autonomous vehicle 104 are provided below with regard to FIG. 2.

In some non-limiting embodiments or aspects, map generation system 102 and/or autonomous vehicle 104 include one or more devices capable of receiving, storing, processing, and/or providing image data (e.g., training data, input data, output data, map data, feature data, classification data, identification data, sensor data, etc.) including one or more images (e.g., one or more images, one or more ground truths of one or more images, one or more perturbed images, one or more generated images, one or more other images, one or more positive samples or examples, one or more negative samples or examples, etc.) of a geographic location or region having a roadway (e.g., a country, a state, a city, a portion of a city, a township, a portion of a township, etc.) and/or one or more objects (e.g., a vehicle, vegetation, a pedestrian, a structure, a building, a sign, a lamp post, a traffic light, a bicycle, a railway track, a hazardous object, etc.). For example, map generation system 102 and/or autonomous vehicle 104 may obtain image data associated with one or more traversals of the roadway by one or more vehicles (e.g., autonomous vehicles, non-autonomous vehicles, etc.). As an example, one or more vehicles can capture (e.g., using one or more cameras, etc.) one or more images of a roadway and/or one or more objects during one or more traversals of the roadway. In some non-limiting embodiments or aspects, image data includes one or more aerial images of a geographic location or region having a roadway and/or one or more objects. For example, one or more aerial vehicles can capture (e.g., using one or more cameras, etc.) one or more images of a roadway and/or one or more objects during one or more flyovers of the geographic location or region.

In some non-limiting embodiments or aspects, map generation system 102 and/or autonomous vehicle 104 include one or more devices capable of receiving, storing, and/or providing map data (e.g., map data, AV map data, coverage map data, hybrid map data, submap data, Uber's Hexagonal Hierarchical Spatial Index (H3) data, Google's S2 geometry data, etc.) associated with a map (e.g., a map, a submap, an AV map, a coverage map, a hybrid map, a H3 cell, a S2 cell, etc.) of a geographic location (e.g., a country, a state, a city, a portion of a city, a township, a portion of a township, etc.). For example, maps can be used for routing autonomous vehicle 104 on a roadway specified in the map.

In some non-limiting embodiments or aspects, a road refers to a paved or otherwise improved path between two places that allows for travel by a vehicle (e.g., autonomous vehicle 104, etc.). Additionally or alternatively, a road includes a roadway and a sidewalk in proximity to (e.g., adjacent, near, next to, touching, etc.) the roadway. In some non-limiting embodiments or aspects, a roadway includes a portion of road on which a vehicle is intended to travel and is not restricted by a physical barrier or by separation so that the vehicle is able to travel laterally. Additionally or alternatively, a roadway includes one or more lanes, such as a travel lane (e.g., a lane upon which a vehicle travels, a traffic lane, etc.), a parking lane (e.g., a lane in which a vehicle parks), a bicycle lane (e.g., a lane in which a bicycle travels), a turning lane (e.g., a lane in which a vehicle turns from), and/or the like. In some non-limiting embodiments or aspects, a roadway is connected to another roadway, for example, a lane of a roadway is connected to another lane of the roadway and/or a lane of the roadway is connected to a lane of another roadway.

In some non-limiting embodiments or aspects, a roadway is associated with map data that defines one or more attributes of (e.g., metadata associated with) the roadway (e.g., attributes of a roadway in a geographic location, attributes of a segment of a roadway), attributes of a lane of a roadway, attributes of an edge of a roadway, attributes of a driving path of a roadway, etc.). In some non-limiting embodiments or aspects, an attribute of a roadway includes a road edge of a road (e.g., a location of a road edge of a road, a distance of location from a road edge of a road, an indication whether a location is within a road edge of a road, etc.), an intersection, connection, or link of a road with another road, a roadway of a road, a distance of a roadway from another roadway (e.g., a distance of an end of a lane and/or a roadway segment or extent to an end of another lane and/or an end of another roadway segment or extent, etc.), a lane of a roadway of a road (e.g., a travel lane of a roadway, a parking lane of a roadway, a turning lane of a roadway, lane markings, a direction of travel in a lane of a roadway, etc.), a centerline of a roadway (e.g., an indication of a centerline path in at least one lane of the roadway for controlling autonomous vehicle 104 during operation (e.g., following, traveling, traversing, routing, etc.) on a driving path, a driving path of a roadway (e.g., one or more trajectories that autonomous vehicle 104 can traverse in the roadway and an indication of the location of at least one feature in the roadway a lateral distance from the driving path, etc.), one or more objects (e.g., a vehicle, vegetation, a pedestrian, a structure, a building, a sign, a lamp post, signage, a traffic sign, a bicycle, a railway track, a hazardous object, etc.) in proximity to and/or within a road (e.g., objects in proximity to the road edges of a road and/or within the road edges of a road), a sidewalk of a road, and/or the like. In some non-limiting embodiments or aspects, output data includes map data. In some non-limiting embodiments or aspects, a map of a geographic location includes one or more routes that include one or more roadways. In some non-limiting embodiments or aspects, map data associated with a map of the geographic location associates each roadway of the one or more roadways with an indication of whether an autonomous vehicle can travel on that roadway.

In some non-limiting embodiments or aspects, a driving path data includes feature data based on features of the roadway (e.g., section of curb, marker, object, etc.) for controlling an autonomous vehicle 104 to autonomously determine objects in the roadway, and a driving path that includes feature data for determining the left and right edges of a lane in the roadway. For example, the driving path data includes a driving path in a lane in the geographic location that includes a trajectory (e.g., a spline, a polyline, etc.), and a location of features (e.g., a portion of the feature, a section of the feature) in the roadway, with a link for transitioning between an entry point and an end point of the driving path based on at least one of heading information, curvature information, acceleration information and/or the like, and intersections with features in the roadway (e.g., real objects, paint markers, curbs, other lane paths) of a lateral region (e.g., polygon) projecting from the path, with objects of interest.

In some non-limiting embodiments or aspects, communication network 108 includes one or more wired and/or wireless networks. For example, communication network 108 includes a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems, devices, and networks shown in FIG. 1 are provided as an example. There can be additional systems, devices, and/or networks, fewer systems, devices, and/or networks, different systems, devices, and/or networks, or differently arranged systems, devices, and/or networks than those shown in FIG. 1. Furthermore, two or more systems or devices shown in FIG. 1 can be implemented within a single system or a single device, or a single system or a single device shown in FIG. 1 can be implemented as multiple, distributed systems or devices. Additionally, or alternatively, a set of systems or a set of devices (e.g., one or more systems, one or more devices) of environment 100 can perform one or more functions described as being performed by another set of systems or another set of devices of environment 100.

Referring now to FIG. 2, FIG. 2 is a diagram of a non-limiting embodiment of a system 200 for controlling autonomous vehicle 104. As shown in FIG. 2, vehicle computing system 106 includes vehicle command system 218, perception system 228, prediction system 230, motion planning system 232, local route interpreter 234, and map geometry system 236 that cooperate to perceive a surrounding environment of autonomous vehicle 104, determine a motion plan of autonomous vehicle 104 based on the perceived surrounding environment, and control the motion (e.g., the direction of travel) of autonomous vehicle 104 based on the motion plan.

In some non-limiting embodiments or aspects, vehicle computing system 106 is connected to or includes positioning system 208. In some non-limiting embodiments or aspects, positioning system 208 determines a position (e.g., a current position, a past position, etc.) of autonomous vehicle 104. In some non-limiting embodiments or aspects, positioning system 208 determines a position of autonomous vehicle 104 based on an inertial sensor, a satellite positioning system, an IP address (e.g., an IP address of autonomous vehicle 104, an IP address of a device in autonomous vehicle 104, etc.), triangulation based on network components (e.g., network access points, cellular towers, Wi-Fi access points, etc.), and/or proximity to network components, and/or the like. In some non-limiting embodiments or aspects, the position of autonomous vehicle 104 is used by vehicle computing system 106.

In some non-limiting embodiments or aspects, vehicle computing system 106 receives sensor data from one or more sensors 210 that are coupled to or otherwise included in autonomous vehicle 104. For example, one or more sensors 210 includes a Light Detection and Ranging (LIDAR) system, a Radio Detection and Ranging (RADAR) system, one or more cameras (e.g., visible spectrum cameras, infrared cameras, etc.), and/or the like. In some non-limiting embodiments or aspects, the sensor data includes data that describes a location of objects within the surrounding environment of autonomous vehicle 104. In some non-limiting embodiments or aspects, one or more sensors 210 collect sensor data that includes data that describes a location (e.g., in three-dimensional space relative to autonomous vehicle 104) of points that correspond to objects within the surrounding environment of autonomous vehicle 104.

In some non-limiting embodiments or aspects, the sensor data includes a location (e.g., a location in three-dimensional space relative to the LIDAR system) of a number of points (e.g., a point cloud) that correspond to objects that have reflected a ranging laser. In some non-limiting embodiments or aspects, the LIDAR system measures distances by measuring a Time of Flight (TOF) that a short laser pulse takes to travel from a sensor of the LIDAR system to an object and back, and the LIDAR system calculates the distance of the object to the LIDAR system based on the known speed of light. In some non-limiting embodiments or aspects, map data includes LIDAR point cloud maps associated with a geographic location (e.g., a location in three-dimensional space relative to the LIDAR system of a mapping vehicle) of a number of points (e.g., a point cloud) that correspond to objects that have reflected a ranging laser of one or more mapping vehicles at the geographic location. As an example, a map can include a LIDAR point cloud layer that represents objects and distances between objects in the geographic location of the map.

In some non-limiting embodiments or aspects, the sensor data includes a location (e.g., a location in three-dimensional space relative to the RADAR system) of a number of points that correspond to objects that have reflected a ranging radio wave. In some non-limiting embodiments or aspects, radio waves (e.g., pulsed radio waves or continuous radio waves) transmitted by the RADAR system can reflect off an object and return to a receiver of the RADAR system. The RADAR system can then determine information about the object's location and/or speed. In some non-limiting embodiments or aspects, the RADAR system provides information about the location and/or the speed of an object relative to the RADAR system based on the radio waves.

In some non-limiting embodiments or aspects, image processing techniques (e.g., range imaging techniques, as an example, structure from motion, structured light, stereo triangulation, etc.) can be performed by system 200 to identify a location (e.g., in three-dimensional space relative to the one or more cameras) of a number of points that correspond to objects that are depicted in images captured by one or more cameras. Other sensors can identify the location of points that correspond to objects as well.

In some non-limiting embodiments or aspects, map database 214 provides detailed information associated with the map, features of the roadway in the geographic location, and information about the surrounding environment of autonomous vehicle 104 for autonomous vehicle 104 to use while driving (e.g., traversing a route, planning a route, determining a motion plan, controlling autonomous vehicle 104, etc.).

In some non-limiting embodiments or aspects, vehicle computing system 106 receives a vehicle pose from localization system 216 based on one or more sensors 210 that are coupled to or otherwise included in autonomous vehicle 104. In some non-limiting embodiments or aspects, localization system 216 includes a LIDAR localizer, a low quality pose localizer, and/or a pose filter. For example, the localization system 216 uses a pose filter that receives and/or determines one or more valid pose estimates (e.g., not based on invalid position data, etc.) from the LIDAR localizer and/or the low quality pose localizer, for determining a map-relative vehicle pose. For example, a low quality pose localizer determines a low quality pose estimate in response to receiving position data from positioning system 208 for operating (e.g., routing, navigating, controlling, etc.) autonomous vehicle 104 under manual control (e.g., in a coverage lane, on a coverage driving path, etc.). In some non-limiting embodiments or aspects, LIDAR localizer determines a LIDAR pose estimate in response to receiving sensor data (e.g., LIDAR data, RADAR data, etc.) from sensors 210 for operating (e.g., routing, navigating, controlling, etc.) autonomous vehicle 104 under autonomous control (e.g., in an AV lane, on an AV driving path, etc.).

In some non-limiting embodiments or aspects, vehicle command system 218 includes vehicle commander system 220, navigator system 222, path and/or lane associator system 224, and local route generator 226 that cooperate to route and/or navigate autonomous vehicle 104 in a geographic location. In some non-limiting embodiments or aspects, vehicle commander system 220 provides tracking of a current objective of autonomous vehicle 104, such as a current service, a target pose, a coverage plan (e.g., development testing, etc.), and/or the like. In some non-limiting embodiments or aspects, navigator system 222 determines and/or provides a route plan (e.g., a route between a starting location or a current location and a destination location, etc.) for autonomous vehicle 104 based on a current state of autonomous vehicle 104, map data (e.g., lane graph, driving paths, etc.), and one or more vehicle commands (e.g., a target pose). For example, navigator system 222 determines a route plan (e.g., a plan, a re-plan, a deviation from a route plan, etc.) including one or more lanes (e.g., current lane, future lane, etc.) and/or one or more driving paths (e.g., a current driving path, a future driving path, etc.) in one or more roadways that autonomous vehicle 104 can traverse on a route to a destination location (e.g., a target location, a trip drop-off location, etc.).

In some non-limiting embodiments or aspects, navigator system 222 determines a route plan based on one or more lanes and/or one or more driving paths received from path and/or lane associator system 224. In some non-limiting embodiments or aspects, path and/or lane associator system 224 determines one or more lanes and/or one or more driving paths of a route in response to receiving a vehicle pose from localization system 216. For example, path and/or lane associator system 224 determines, based on the vehicle pose, that autonomous vehicle 104 is on a coverage lane and/or a coverage driving path, and in response to determining that autonomous vehicle 104 is on the coverage lane and/or the coverage driving path, determines one or more candidate lanes (e.g., routable lanes, etc.) and/or one or more candidate driving paths (e.g., routable driving paths, etc.) within a distance of the vehicle pose associated with autonomous vehicle 104. For example, path and/or lane associator system 224 determines, based on the vehicle pose, that autonomous vehicle 104 is on an AV lane and/or an AV driving path, and in response to determining that autonomous vehicle 104 is on the AV lane and/or the AV driving path, determines one or more candidate lanes (e.g., routable lanes, etc.) and/or one or more candidate driving paths (e.g., routable driving paths, etc.) within a distance of the vehicle pose associated with autonomous vehicle 104. In some non-limiting embodiments or aspects, navigator system 222 generates a cost function for each of the one or more candidate lanes and/or the one or more candidate driving paths that autonomous vehicle 104 may traverse on a route to a destination location. For example, navigator system 222 generates a cost function that describes a cost (e.g., a cost over a time period) of following (e.g., adhering to) one or more lanes and/or one or more driving paths that may be used to reach the destination location (e.g., a target pose, etc.).

In some non-limiting embodiments or aspects, local route generator 226 generates and/or provides route options that may be processed and control travel of autonomous vehicle 104 on a local route. For example, navigator system 222 may configure a route plan, and local route generator 226 may generate and/or provide one or more local routes or route options for the route plan. For example, the route options may include one or more options for adapting the motion of the AV to one or more local routes in the route plan (e.g., one or more shorter routes within a global route between the current location of the AV and one or more exit locations located between the current location of the AV and the destination location of the AV, etc.). In some non-limiting embodiments or aspects, local route generator 226 may determine a number of route options based on a predetermined number, a current location of the AV, a current service of the AV, and/or the like.

In some non-limiting embodiments or aspects, perception system 228 detects and/or tracks objects (e.g., vehicles, pedestrians, bicycles, and the like) that are proximate to (e.g., in proximity to the surrounding environment of) autonomous vehicle 104 over a time period. In some non-limiting embodiments or aspects, perception system 228 can retrieve (e.g., obtain) map data from map database 214 that provides detailed information about the surrounding environment of autonomous vehicle 104.

In some non-limiting embodiments or aspects, perception system 228 determines one or more objects that are proximate to autonomous vehicle 104 based on sensor data received from one or more sensors 210 and/or map data from map database 214. For example, perception system 228 determines, for the one or more objects that are proximate, state data associated with a state of such an object. In some non-limiting embodiments or aspects, the state data associated with an object includes data associated with a location of the object (e.g., a position, a current position, an estimated position, etc.), data associated with a speed of the object (e.g., a magnitude of velocity of the object), data associated with a direction of travel of the object (e.g., a heading, a current heading, etc.), data associated with an acceleration rate of the object (e.g., an estimated acceleration rate of the object, etc.), data associated with an orientation of the object (e.g., a current orientation, etc.), data associated with a size of the object (e.g., a size of the object as represented by a bounding shape, such as a bounding polygon or polyhedron, a footprint of the object, etc.), data associated with a type of the object (e.g., a class of the object, an object with a type of vehicle, an object with a type of pedestrian, an object with a type of bicycle, etc.), and/or the like.

In some non-limiting embodiments or aspects, perception system 228 determines state data for an object over a number of iterations of determining state data. For example, perception system 228 updates the state data for each object of a plurality of objects during each iteration.

In some non-limiting embodiments or aspects, prediction system 230 receives the state data associated with one or more objects from perception system 228. Prediction system 230 predicts one or more future locations for the one or more objects based on the state data. For example, prediction system 230 predicts the future location of each object of a plurality of objects within a time period (e.g., 5 seconds, 10 seconds, 20 seconds, etc.). In some non-limiting embodiments or aspects, prediction system 230 predicts that an object will adhere to the object's direction of travel according to the speed of the object. In some non-limiting embodiments or aspects, prediction system 230 uses machine learning techniques or modeling techniques to make a prediction based on state data associated with an object.

In some non-limiting embodiments or aspects, motion planning system 232 determines a motion plan for autonomous vehicle 104 based on a prediction of a location associated with an object provided by prediction system 230 and/or based on state data associated with the object provided by perception system 228. For example, motion planning system 232 determines a motion plan (e.g., an optimized motion plan) for autonomous vehicle 104 that causes autonomous vehicle 104 to travel relative to the object based on the prediction of the location for the object provided by prediction system 230 and/or the state data associated with the object provided by perception system 228.

In some non-limiting embodiments or aspects, motion planning system 232 receives a route plan as a command from navigator system 222. In some non-limiting embodiments or aspects, motion planning system 232 determines a cost function for one or more motion plans of a route for autonomous vehicle 104 based on the locations and/or predicted locations of one or more objects. For example, motion planning system 232 determines the cost function that describes a cost (e.g., a cost over a time period) of following (e.g., adhering to) a motion plan (e.g., a selected motion plan, an optimized motion plan, etc.). In some non-limiting embodiments or aspects, the cost associated with the cost function increases and/or decreases based on autonomous vehicle 104 deviating from a motion plan (e.g., a selected motion plan, an optimized motion plan, a preferred motion plan, etc.). For example, the cost associated with the cost function increases and/or decreases based on autonomous vehicle 104 deviating from the motion plan to avoid a collision with an object.

In some non-limiting embodiments or aspects, motion planning system 232 determines a cost of following a motion plan. For example, motion planning system 232 determines a motion plan for autonomous vehicle 104 based on one or more cost functions. In some non-limiting embodiments or aspects, motion planning system 232 determines a motion plan (e.g., a selected motion plan, an optimized motion plan, a preferred motion plan, etc.) that minimizes a cost function. In some non-limiting embodiments or aspects, motion planning system 232 provides a motion plan to vehicle controls 240 (e.g., a device that controls acceleration, a device that controls steering, a device that controls braking, an actuator that controls gas flow, etc.) to implement the motion plan.

In some non-limiting embodiments or aspects, motion planning system 232 communicates with local route interpreter 234 and map geometry system 236. In some non-limiting embodiments or aspects, local route interpreter 234 may receive and/or process route options from local route generator 226. For example, local route interpreter 234 may determine a new or updated route for travel of autonomous vehicle 104. As an example, one or more lanes and/or one or more driving paths in a local route may be determined by local route interpreter 234 and map geometry system 236. For example, local route interpreter 234 can determine a route option and map geometry system 236 determines one or more lanes and/or one or more driving paths in the route option for controlling motion of autonomous vehicle 104.

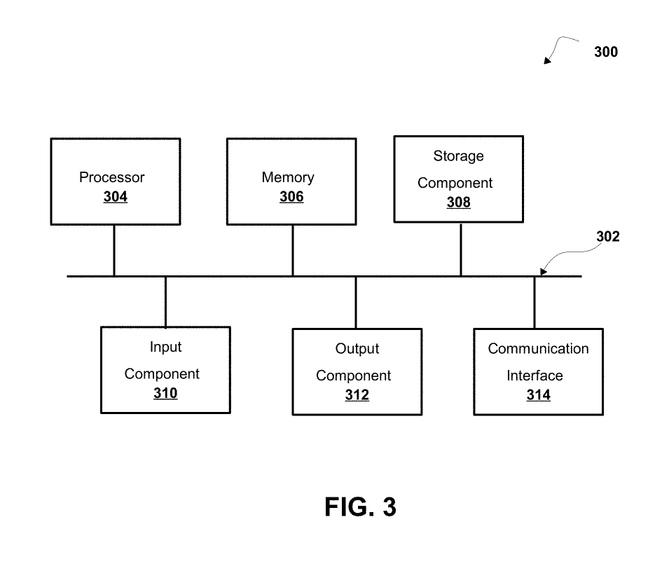

Referring now to FIG. 3, FIG. 3 is a diagram of example components of a device 300. Device 300 can correspond to one or more devices of map generation system 102 and/or one or more devices (e.g., one or more devices of a system of) autonomous vehicle 104. In some non-limiting embodiments or aspects, one or more devices of map generation system 102 and/or one or more devices (e.g., one or more devices of a system of) autonomous vehicle 104 can include at least one device 300 and/or at least one component of device 300. As shown in FIG. 3, device 300 includes bus 302, processor 304, memory 306, storage component 308, input component 310, output component 312, and communication interface 314.

Bus 302 includes a component that permits communication among the components of device 300. In some non-limiting embodiments or aspects, processor 304 is implemented in hardware, firmware, or a combination of hardware and software. For example, processor 304 includes a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 306 includes a random access memory (RAM), a read only memory (ROM), and/or another type of dynamic or static storage device (e.g., flash memory, magnetic memory, optical memory, etc.) that stores information and/or instructions for use by processor 304.

Storage component 308 stores information and/or software related to the operation and use of device 300. For example, storage component 308 includes a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 310 includes a component that permits device 300 to receive information, such as via user input (e.g., a touch screen display, a keyboard, a keypad, a mouse, a button, a switch, a microphone, etc.). Additionally, or alternatively, input component 310 includes a sensor for sensing information (e.g., a global positioning system (GPS) component, an accelerometer, a gyroscope, an actuator, etc.). Output component 312 includes a component that provides output information from device 300 (e.g., a display, a speaker, one or more light-emitting diodes (LEDs), etc.).

Communication interface 314 includes a transceiver-like component (e.g., a transceiver, a separate receiver and transmitter, etc.) that enables device 300 to communicate with other devices, such as via a wired connection, a wireless connection, or a combination of wired and wireless connections. Communication interface 314 can permit device 300 to receive information from another device and/or provide information to another device. For example, communication interface 314 includes an Ethernet interface, an optical interface, a coaxial interface, an infrared interface, a radio frequency (RF) interface, a universal serial bus (USB) interface, a Wi-Fi interface, a cellular network interface, and/or the like.

Device 300 can perform one or more processes described herein. Device 300 can perform these processes based on processor 304 executing software instructions stored by a computer-readable medium, such as memory 306 and/or storage component 308. A computer-readable medium (e.g., a non-transitory computer-readable medium) is defined herein as a non-transitory memory device. A memory device includes memory space located inside of a single physical storage device or memory space spread across multiple physical storage devices.

Software instructions can be read into memory 306 and/or storage component 308 from another computer-readable medium or from another device via communication interface 314. When executed, software instructions stored in memory 306 and/or storage component 308 cause processor 304 to perform one or more processes described herein. Additionally, or alternatively, hardwired circuitry can be used in place of or in combination with software instructions to perform one or more processes described herein. Thus, embodiments described herein are not limited to any specific combination of hardware circuitry and software.

The number and arrangement of components shown in FIG. 3 are provided as an example. In some non-limiting embodiments or aspects, device 300 includes additional components, fewer components, different components, or differently arranged components than those shown in FIG. 3. Additionally, or alternatively, a set of components (e.g., one or more components) of device 300 can perform one or more functions described as being performed by another set of components of device 300.

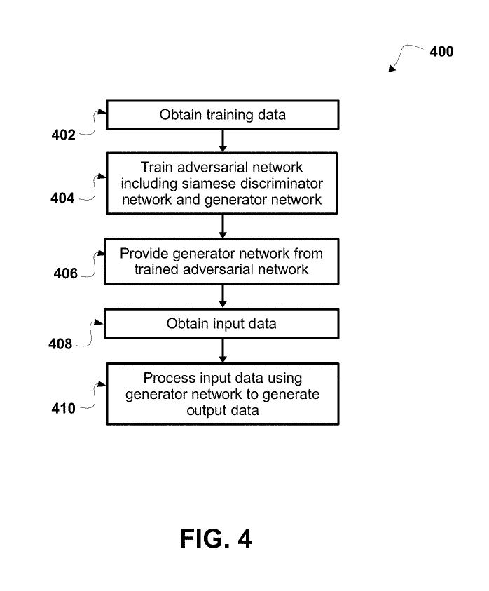

Referring now to FIG. 4, FIG. 4 is a flowchart of a non-limiting embodiment of a process 400 for training, providing, and/or using an adversarial network. In some non-limiting embodiments or aspects, one or more of the steps of process 400 are performed (e.g., completely, partially, etc.) by map generation system 102 (e.g., one or more devices of map generation system 102, etc.). In some non-limiting embodiments or aspects, one or more of the steps of process 400 are performed (e.g., completely, partially, etc.) by another device or a group of devices separate from or including map generation system 102, such as autonomous vehicle 104 (e.g., one or more devices of autonomous vehicle 104, etc.).

As shown in FIG. 4, at step 402, process 400 includes obtaining training data. For example, map generation system 102 obtains training data. As an example, map generation system 102 obtains (e.g., receives, retrieves, etc.) training data from one or more databases and/or sensors.

In some non-limiting embodiments or aspects, training data includes image data. For example, training data includes one or more images and one or more ground truth labels of the one or more images. As an example, training data includes one or more images of a geographic location or region having a roadway (e.g., a country, a state, a city, a portion of a city, a township, a portion of a township, etc.) and/or one or more objects, and one or more ground truth labels (e.g., one or more ground truth images, etc.) of the one or more images. In some non-limiting embodiments or aspects, a ground truth label of an image includes a ground truth semantic segmentation of the image (e.g., classification data representing a classification of one or more objects in the image within a plurality of predetermined classifications, etc.), a ground truth road centerline extraction of the image (e.g., feature data representing an extracted centerline of a roadway in the image, etc.), a ground truth instance segmentation of the image (e.g., identification data representing an identification, such as a bounding box, a polygon, and/or the like, of one or more objects in the image, etc.), and/or the like. For example, a ground truth label of an image may include an overlay over the image that represents a classification of one or more objects in the image within a plurality of predetermined classifications, an extracted centerline of a roadway in the image, an identification of one or more objects in the image, and/or the like.

As shown in FIG. 4, at step 404, process 400 includes training an adversarial network including a siamese discriminator network and a generator network. For example, map generation system 102 trains an adversarial network including a siamese discriminator network and a generator network. As an example, map generation system 102 trains an adversarial network including a siamese discriminator network and a generator network with training data.

In some non-limiting embodiments or aspects, map generation system 102 generates, with the generator network, one or more generated images based on the one or more images. For example, map generation system 102 generates, with the generator network, a generated image based on an image that attempts to match or generate a ground truth label of the image. As an example, map generation system 102 generates classification data representing a classification of one or more objects in the image within a plurality of predetermined classifications, feature data representing an extracted centerline of a roadway in the image, identification data representing an identification (e.g., a bounding box, a polygon, etc.) of one or more objects in the image, and/or the like.

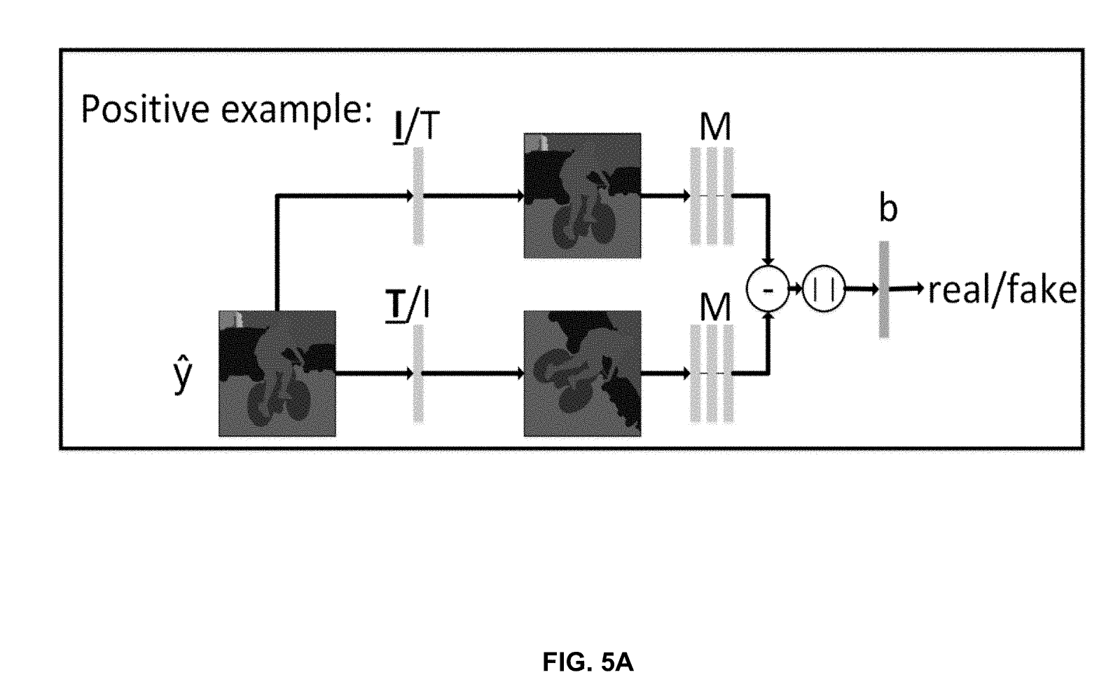

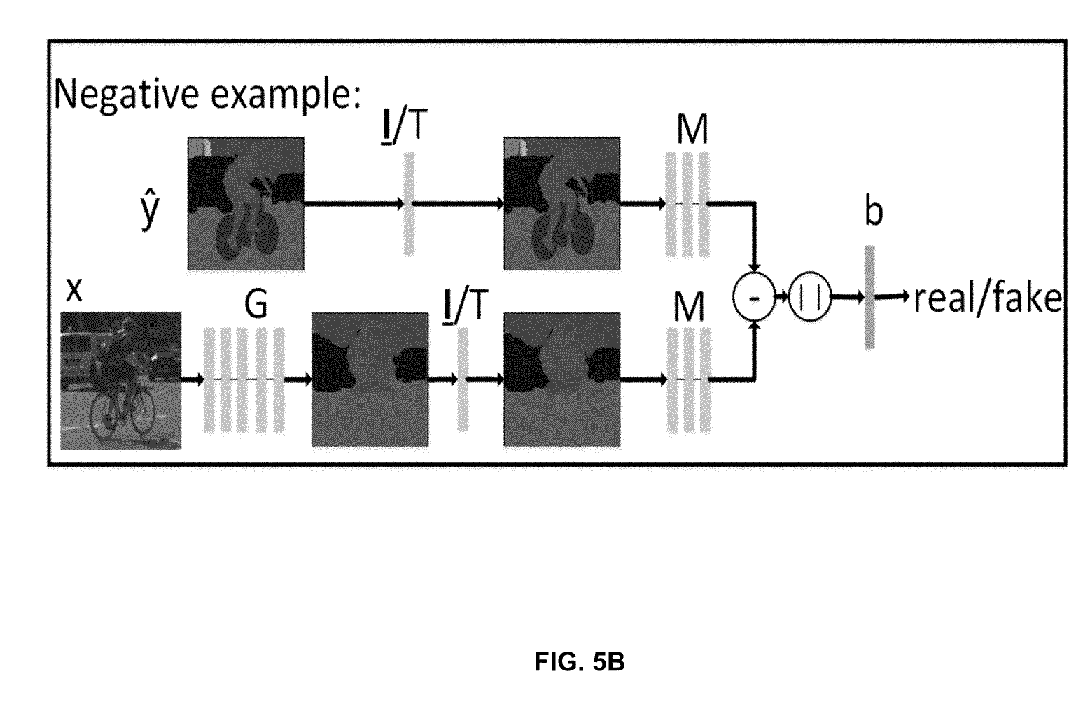

In some not limiting embodiments or aspects, map generation system 102 processes, with the siamese discriminator network, at least one pair of images including: (i) a ground truth label of the one or more ground truth labels of the one or more images; and (ii) one of: (a) a generated image of the one or more generated images generated by the generator network; and (b) a perturbed image of the ground truth label of the one or more ground truth labels of the one or more images, to determine a prediction of whether the at least one pair of images includes the one or more generated images. For example, and referring also to FIGS. 5A and 5B, a positive sample or example of training data input to the siamese discriminator network may include a pair of images including: (i) a ground truth label of the one or more ground truth labels of the one or more images; and (ii) a perturbed image of the ground truth label of the one or more ground truth labels of the one or more images, and a negative sample or example of training data input to the siamese discriminator network may include a pair of images including: (i) a ground truth label of the one or more ground truth labels of the one or more images; and (ii) a generated image of the one or more generated images generated by the generator network. As an example, a siamese architecture is used for a discriminator in the adversarial network to exploit the training points (e.g., the positive samples, the negative samples, etc.) explicitly in a loss function of the adversarial network. In such an example, no additional discriminative loss function may be necessary for training the adversarial network.

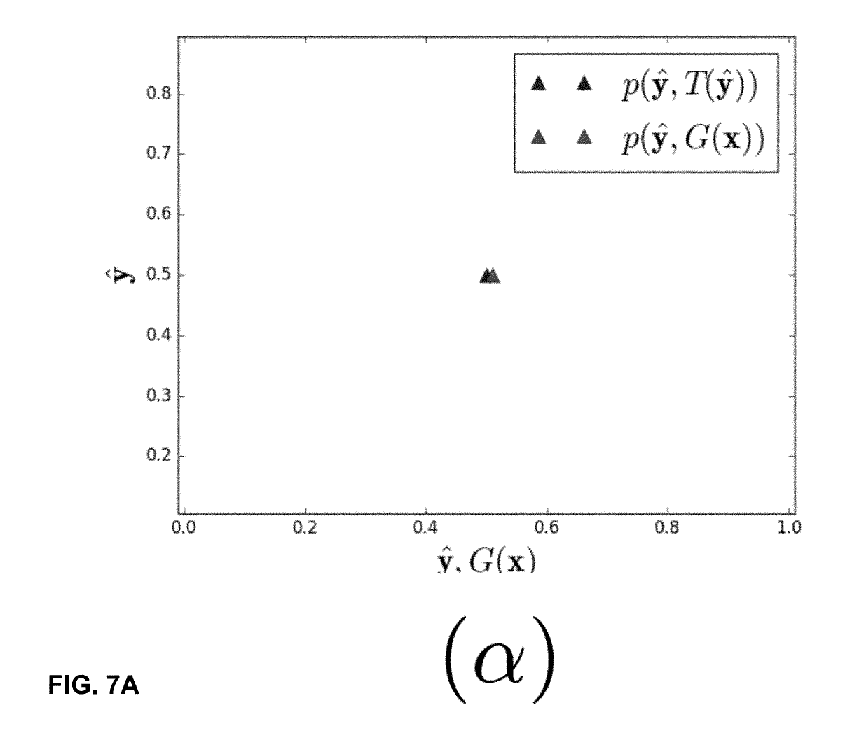

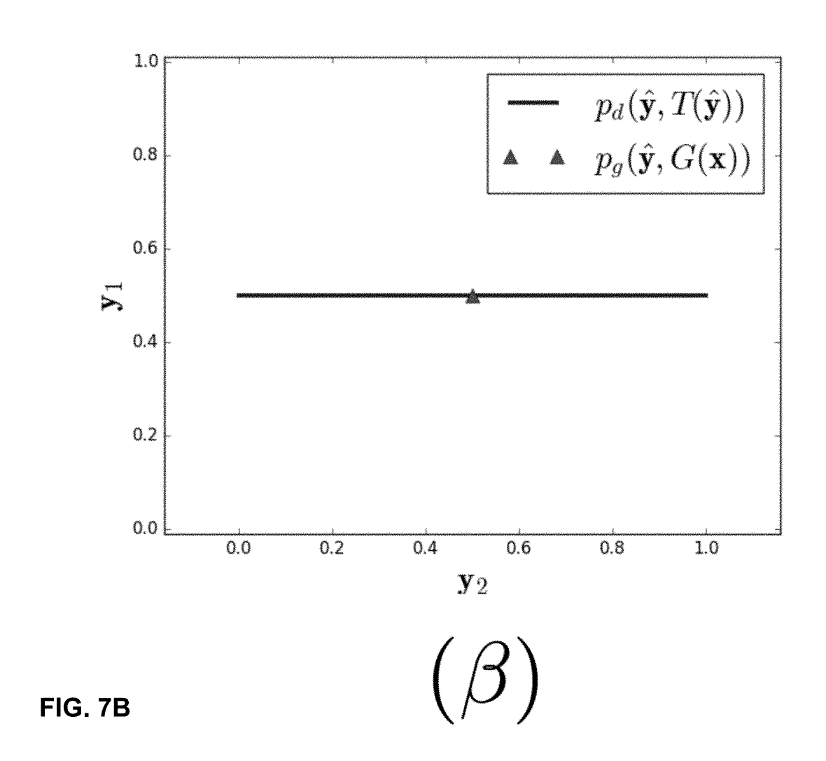

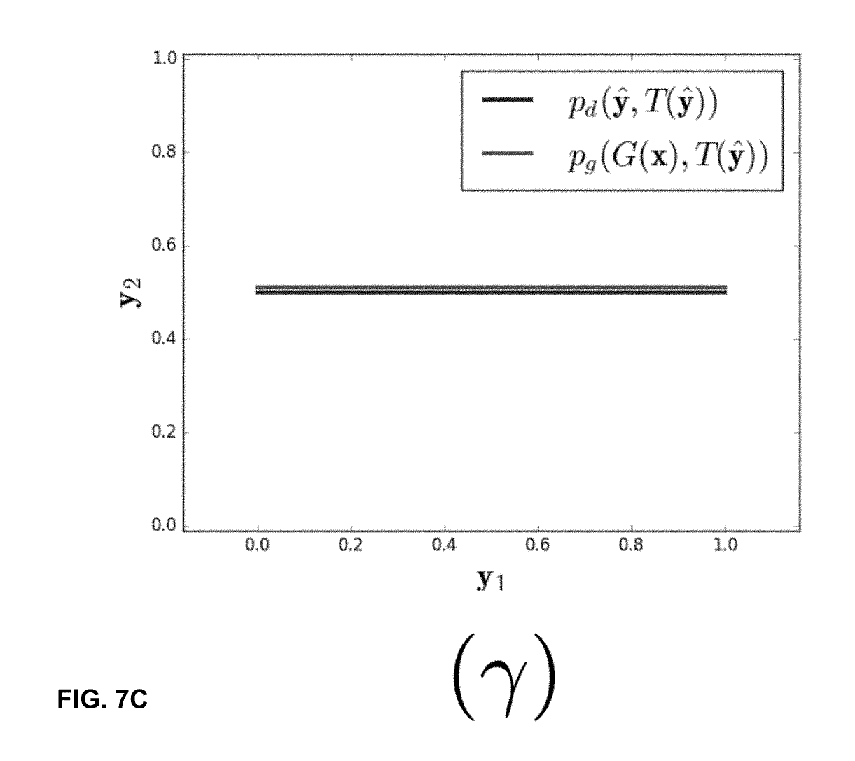

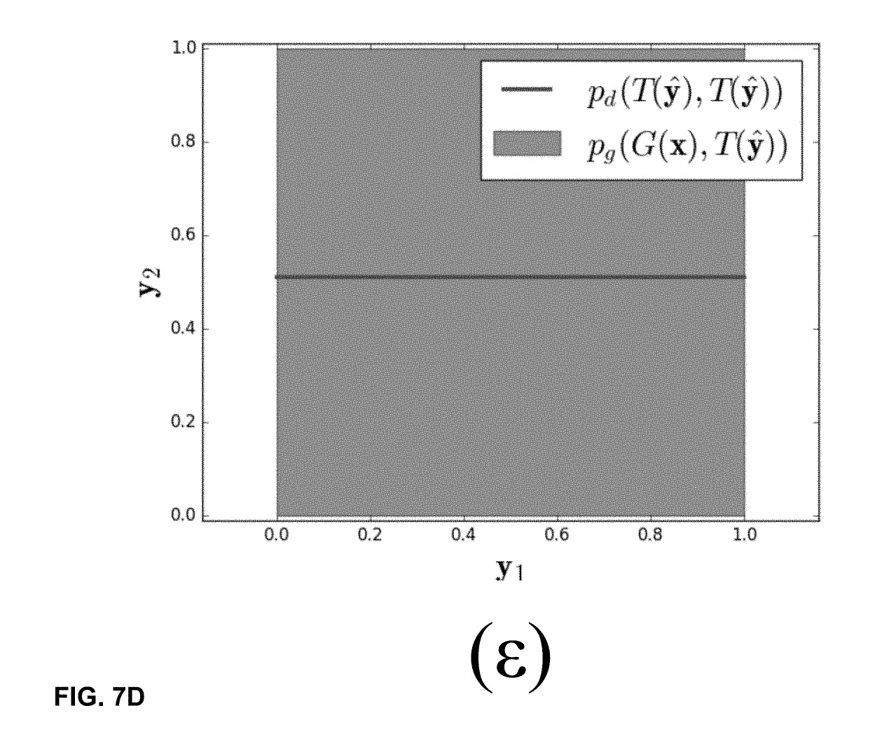

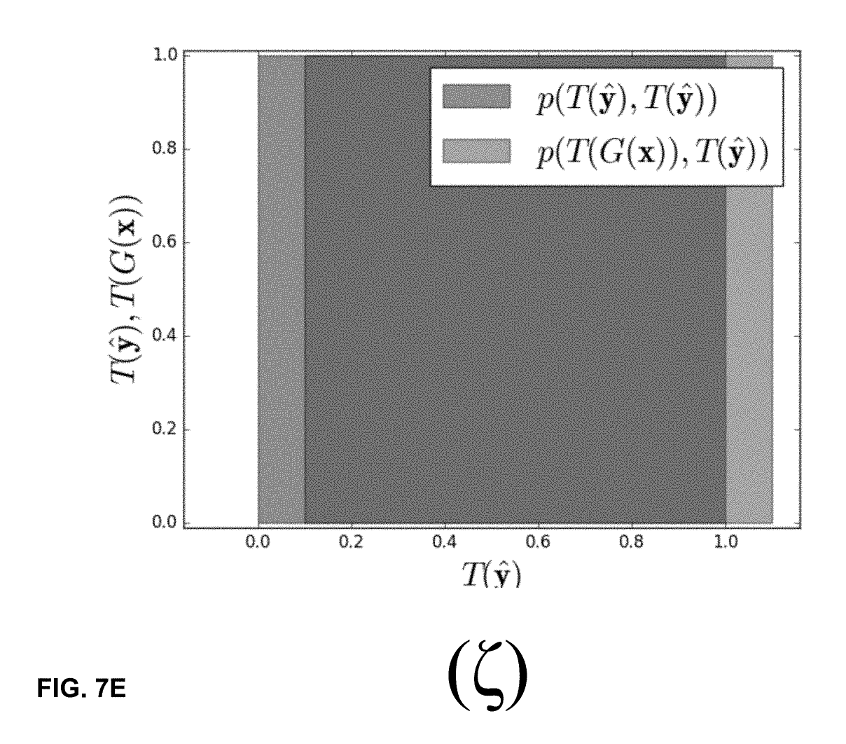

In some non-limiting embodiments or aspects, and still referring to FIGS. 5A and 5B, branches or inputs y₁, y₂ of the siamese discriminator network receive as input either perturbations (e.g., random transformations, etc.) of the ground truth, yᵢ=Tᵢ(ŷ) or a generated output y₂=T_{g}(G(x)). For example, depending on a configuration of the perturbations, denoted as t, the perturbation can be set to identity transformation Tᵢ( )=I( ) (e.g., neglecting the perturbation, etc.). As an example, input to the siamese discriminator network can be passed through a perturbation T or through an identity transformation I, and the configurations of T and I result in different training behavior for a MatAN according to some non-limiting embodiments or aspects as discussed in more detail herein with respect to FIGS. 7A-7E. FIGS. 5A and 5B show a non-limiting embodiment or aspect in which a perturbation is applied only to a single branch of the input for the positive samples; however, non-limiting embodiments or aspects are not limited thereto, and map generation system 102 can apply a perturbation to none, all, or any combination of the branches y₁, y₂ of the input to the siamese discriminator network for the positive samples and/or the negative samples.

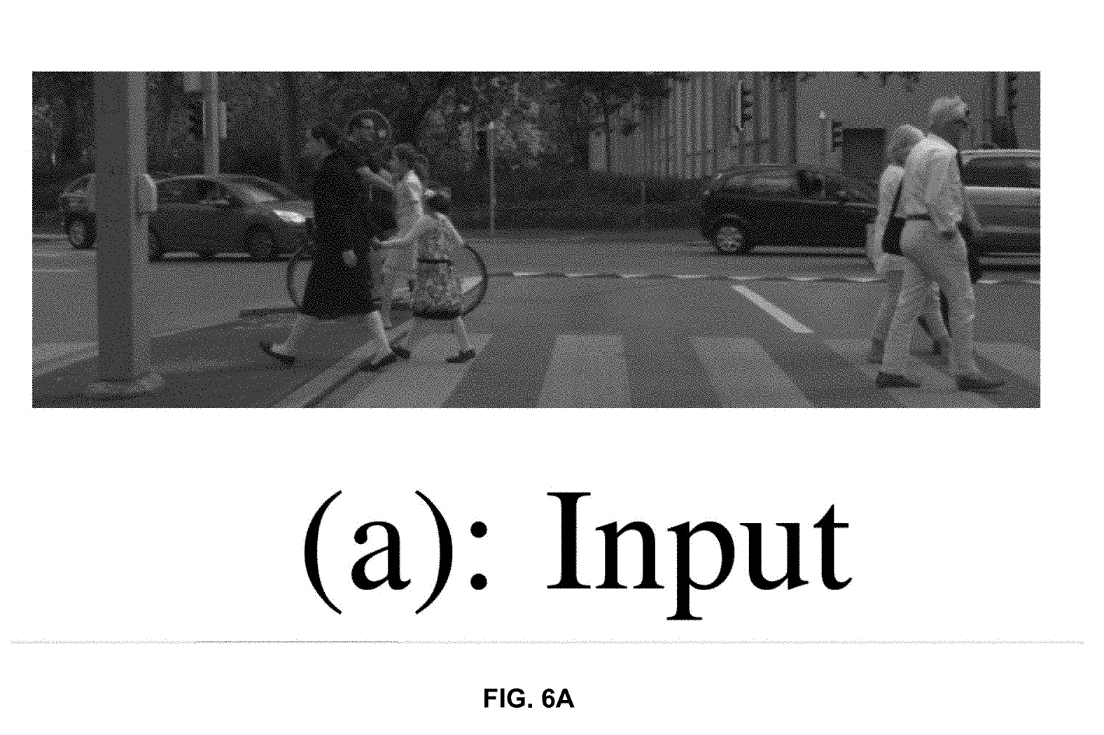

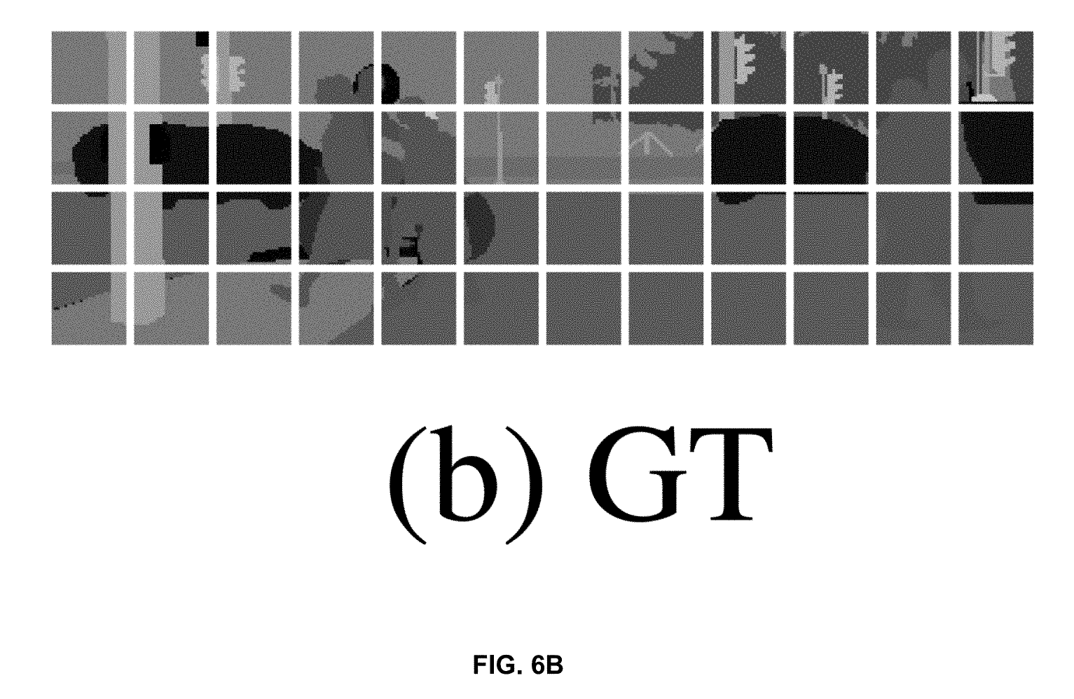

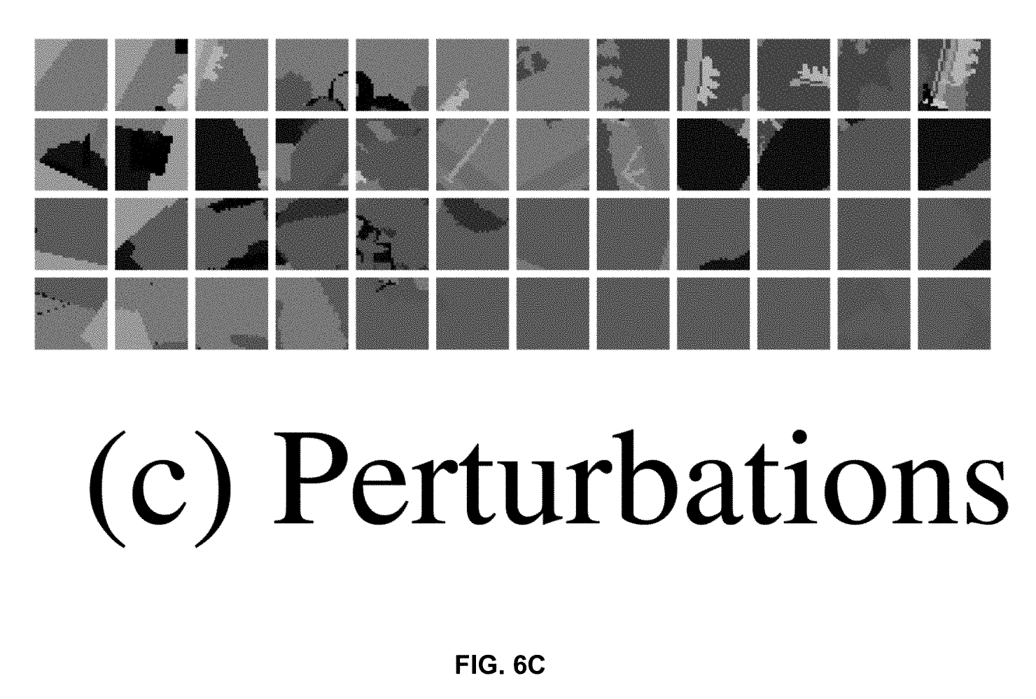

FIGS. 6A-6C show an example of perturbations employed for a semantic segmentation task. For example, FIG. 6A shows (a) an example input image (e.g., a Cityscapes input image, etc.), FIG. 6B shows (b) a corresponding ground truth (GT) of the input image divided in patches, and FIG. 6C shows (c) example rotation perturbations applied independently patch-wise on the ground truth. As an example, the siamese discriminator network can include a patch-wise siamese discriminator network. For example, map generation system 102 can divide an image into relatively small overlapping patches and use each patch as an independent training example for training a MatAN. As an example, map generation system 102 can apply as a perturbation random rotations in the range of [0°, 360° ] with random flips resulting in a uniform angle distribution. In such an example, map generation system 102 can implement the rotation over a larger patch than the target to avoid boundary effects. As shown in FIGS. 6A-6C, in some non-limiting embodiments or aspects, the perturbations can be applied independently to each patch and, thus, the siamese discriminator network may not be applied in a convolutional manner.

In some non-limiting embodiments or aspects, processing, with the siamese discriminator network, the at least one pair of images includes receiving, with a first branch y₁ of the siamese discriminator network, as a first siamese input; the ground truth label of the one or more ground truth labels of the one or more images, and receiving, with a second branch y₂₀f the siamese discriminator network, as a second siamese input, one of: (a) the generated image of the one or more generated images generated by the generator network; and (b) the perturbed image of the ground truth label of the one or more ground truth labels of the one or more images. For example, the first branch of the siamese discriminator network applies a first complex multi-layer non-linear transformation to the first siamese input to map the first siamese input to a first feature vector, and the second branch of the siamese discriminator network applies a second complex multi-layer non-linear transformation to the second siamese input to map the second siamese input to a second feature vector. As an example, each branch y₁, y₂ of the siamese network undergoes a complex multi-layer non-linear transformation with parameters θ_{M} mapping the input yᵢ; to a feature space or vector m(y, θ_{M}).

In such an example, the first feature vector and the second feature vector can be combined in a combined feature vector, and the prediction of whether the at least one pair of images includes the one or more generated images may be determined based on the combined feature vector. For example, d is calculated as an elementwise absolute value (e.g., abs) applied to the difference of the two feature vectors m( ) output from the two branches y₁, y₂ of the siamese discriminator network according to the following Equation (2):

d(y₁,y₂,θ_{M})=abs(m(y₁,θ_{M})−m(y₂,θ_{M})) (2)

The siamese discriminator network predicts whether a sample pair of inputs (e.g., a pair of images, etc.) is fake or real (e.g., whether the pair of images is a positive sample or a negative sample, whether the pair of images includes a generated image or a perturbation of the ground truth and the ground truth, etc.) based on the negative mean of the d vector by applying a linear transformation followed by a sigmoid function according to the following Equation (3):

$$D ( {y}_{1} , {y}_{2} , b , {Θ}_{M} ) = σ ( - {\sum }_{i}^{K} {d}_{i} ( {y}_{1} , {y}_{2} , {Θ}_{M} ) / K + b ) \qquad ( 3 )$$

In Equation (3), b is a trained bias and K is a number of features. Equation (3) ensures that a magnitude of d is smaller for positive examples and larger for negative (e.g., generated, etc.) samples.

In some non-limiting embodiments or aspects, map generation system 102 modifies, using a loss function of the adversarial network that depends on the ground truth label and the prediction, one or more parameters of the generator network, and/or modifies, using the loss function of the adversarial network that depends on the ground truth label and the prediction, one or more parameters of the siamese discriminator network. For example, map generation system 102 can iteratively alternate between: (i) modifying the one or more parameters of the generator network to optimize the loss function of the adversarial network with respect to the one or more parameters of the generator network; and (ii) modifying the one or more parameters of the siamese discriminator network to optimize the loss function of the adversarial network with respect to the one or more parameters of the siamese discriminator network. As an example, an adversarial network including a siamese discriminator network and a generator network can be trained as a minimax game with an objective defined according to the following Equation (4):

$${min}_{{Θ}_{G}} {max}_{{Θ}_{M} , b} {ℒ}_{MAN} ( {y}_{1} , {y}_{2} ) , x , {Θ}_{M} , {Θ}_{G} ) = {E}_{y 1 , y 2 \sim {p}_{data} ( x , y , t )} log D ( {y}_{1} , {y}_{2} ) , {Θ}_{M} , b , ) + {E}_{y 1 , x \sim {p}_{data} ( x , y , t )} log ( 1 - D ( {y}_{1} , {T}_{g} ( G ( x , {Θ}_{G} ) ) , {Θ}_{M} , b ) ) ) \qquad ( 4 )$$

In some non-limiting embodiments or aspects, the noise term used in a GAN/CGAN is omitted to perform deterministic predictions. For example, the generator network generates a generated image based on an image x. In some non-limiting embodiments or aspects, optimization is performed by alternating between updating the discriminator parameters and the generator parameters and applying the modified generator loss according to the following Equation (5):

[symbol]

_{MAN,G}=−log D(T₁(ŷₙ),Y_{g}(G(xₙ,θ_{G})),|θ_{M},b) (5)

Equation (4) and, for example, the first term thereof as defined according to Equation (5) enable a generator network to match the generated output to the ground truth labels, which provides the target to learn the ground truth to be applied as negative samples (e.g., fake pairs, etc.) for training the discriminator to differentiate between negative samples (e.g., image pairs including the generated output, etc.) and positive samples. In such an example, the perturbations can render matching of the ground truth (e.g., positive samples to the discriminator, etc.) non-trivial, which may otherwise be trivial if the input of the siamese branches y₁, y₂ is identical, resulting always in d=0.

In some non-limiting embodiments or aspects, the perturbations do not change the generator target, and the generator learns the ground truth despite applying random perturbations to the ground truth. For example, a joint probability distribution of the branch inputs to the siamese discriminator network (e.g., an extension of a GAN to two variable joint distributions, etc.) can be analyzed to determine an effect of the perturbations on the training behavior and/or performance of a MatAN. As an example, map generation system 102 can apply a simplified model assuming one training sample and a perturbation, which transforms the training sample to a uniform distribution. In such an example, for multiple training samples input to a MatAN, the distribution of the ground truth includes multiple points.

In some non-limiting embodiments or aspects, the first input of the siamese discriminator network may be y₁=T₁(ŷ), and the second input of the siamese discriminator network may be y₂=T₂(ŷ) for the positive samples and y₂=T_{g}(G(x)) for the negative samples. For example, T₁, T₂, T_{g} may be the identity transformation, depending on a Tᵢ( ) configuration. As an example, for a given t perturbation configuration, a discriminator loss function can be defined according to the following Equation (6):

[symbol]

_{MAN,D}= [symbol] _{y}_{₁}_{,y}_{₂}_{˜p}_{_{d}}_{(y}_{₁}_{,y}_{₂}₎log(D(y₁,y₂)+ [symbol] _{y}_{₁}_{,y}_{₂}_{˜p}_{_{g}}_{(y}_{₁}_{,y}_{₂}₎log(1−D(y₁,y₂)) (6)

In Equation (6), p_{d}( ) is the joint distribution of T₁, T₂(ŷ) and p_{g}( ) is the joint distribution of T₁(ŷ) and T_{g}(G(x)). An optimal value of the siamese discriminator network for a fixed G can be determined according to the following Equation (7):

$$D * ( {y}_{1} , {y}_{2} ) = \frac{{p}_{d} ( {y}_{1} , {y}_{2} )}{{p}_{d} ( {y}_{1} , {y}_{2} ) + {p}_{g} ( {y}_{1} , {y}_{2} )} \qquad ( 7 )$$

In some non-limiting embodiments or aspects, an equilibrium of the adversarial training occurs when D=½, p_{d}=p_{g}, and/or the ground truth and the generated data distributions (e.g., the generated image, etc.) match. For example, equilibrium of a MatAN depends on which non-identity perturbations are applied to the inputs y₁, y₂ of the siamese discriminator network. As an example, and referring now to FIGS. 7A-7E, joint probability distributions of implementations (α), (β), (γ), (δ), (ε), and (ζ) of perturbation configurations for a MatAN according to some non-limiting embodiments or aspects respectively provide the following equilibrium conditions for the MatAN.

(α): T₁( )=T₂( )=T_{g}( )=I( ): Equilibrium can be achieved if ŷ=G(x); however, because d(ŷ, ŷ)=0, regardless of m( ), implementation (α) may be a trivial implementation.

(β): T₁( )=T_{g}( )=I( ): Only T₂(ŷ) perturbation is applied. Here p_{g}(y₁, y₂) is approximately a Dirac-delta, thus p_{g}(ŷ, G(x))»p_{d}(ŷ, T₂(ŷ)) always, which implies that the equilibrium of D=½ is not achievable. However, because d is the output of a siamese discriminator network d(G(x), ŷ)=0, if G(x)=ŷ, and because D is a monotonically decreasing function of d(G(x), ŷ) and d≥0, the maximum is at G(x)=ŷ such that the discriminator values for the generator after discriminator training are D(ŷ, ŷ)>D*(ŷ, T(ŷ))>D*(ŷ, y), y∉T(ŷ), and the generator loss has a minimum in ŷ. For example, in an implementation (β) of a perturbation configuration for a MatAN according to some non-limiting embodiments or aspects, the MatAN converges toward G(x)=ŷ.

(γ): T₂( )=T_{g}( )=I( ): Only T₁(ŷ) is applied. Equilibrium can be achieved if G(x)=ŷ, because in this case the two joint distributions p_{d}, p_{g} match.

(δ): T₁( )=I ( ): T2(ŷ) and Tg( ) are applied. Equilibrium can be achieved if G(x)∈T2(̂y), because in this case the two joint distributions p_{d}, p_{g} match. For example, implementation (δ) (not shown in FIGS. 7A-7E), when T₁=I, is the transposed of implementation (γ), which can achieve equilibrium if G(x)∈T₂(ŷ).

(ε): Only T_{g}( )=I( ). Because p_{g}(T₁(ŷ), G(x))»p_{d}(T₁(ŷ), T₂(ŷ)), there is no equilibrium. For example, implementation (E) may not achieve equilibrium and the MatAN may not be converging.

(ζ): All perturbations are applied. Equilibrium is achievable if G(x)∈T(ŷ), the generator produces any of the perturbations.

As shown in FIG. 4, at step 406, process 400 includes providing the generator network from the trained adversarial network. For example, map generation system 102 provides the generator network from the trained adversarial network. As an example, map generation system 102 provides the generator network including the one or more parameters that have been modified based on the loss function of the adversarial network that depends on the ground truth label and the prediction. In some non-limiting embodiments or aspects, map generation system 102 provides the trained generator network at map generation system 102 and/or to (e.g., via transmission over communication network 108, etc.) autonomous vehicle 104.

As shown in FIG. 4, at step 408, process 400 includes obtaining input data. For example, map generation system 102 obtains input data. As an example, map generation system 102 obtains (e.g., receives, retrieves, etc.) input data from one or more databases and/or one or more sensors.

In some non-limiting embodiments or aspects, input data includes one or more other images. For example, the one or more other images may be different than the one or more images included in the training data. As an example, the one or more other images may include an image of a geographic region having a roadway and/or one or more objects. In some non-limiting embodiments or aspects, input data includes sensor data from one or more sensors 210 that are coupled to or otherwise included in autonomous vehicle 104. In some non-limiting embodiments or aspects, input data includes one or more aerial images of a geographic location or region having a roadway and/or one or more objects.

As shown in FIG. 4, at step 410, process 400 includes processing input data using the generator network to obtain output data. For example, map generation system 102 processes, using the generator network, the input data to generate output data. As an example, map generation system 102 can use the trained generator network to perform at least one of following on the one or more other images in the input data to generate output data: semantic segmentation, road network centerline extraction, instance segmentation, or any combination thereof. In such an example, map generation system 102 can provide the output data to a user (e.g., via output component 312, etc.) and/or to autonomous vehicle 104 (e.g., for use in controlling autonomous vehicle 104 during fully autonomous operation, etc.).

In some non-limiting embodiments or aspects, output data includes at least one of the following: feature data representing an extracted centerline of the roadway; classification data representing a classification of each of the one or more objects within a plurality of predetermined classifications; identification data representing an identification of the one or more objects; image data; or any combination thereof. For example, map generation system 102 can process, using the generator network, one or more other images received as input data that include an image of a geographic region having a roadway to generate a driving path in the roadway to represent an indication of a centerline path in the roadway (e.g., an overlay for the one or more other images showing the centerline path in the roadway, etc.). As an example, map generation system 102 can process, using the generator network, one or more other images received as input data that include an image of one or more objects to generate a classification of each of the one or more objects within a plurality of predetermined classifications (e.g., a classification of a type of object, such as, a building, a vehicle, a bicycle, a pedestrian, a roadway, a background, etc.). For example, map generation system 102 can process, using the generator network, one or more other images received as input data that include an image of one or more objects to generate identification data representing an identification of the one or more objects (e.g., a bounding box, a polygon, and/or the like identifying and/or surrounding the one or more objects in the one or more other images, etc.).

In some non-limiting embodiments or aspects, autonomous vehicle 104 (e.g., vehicle computing system 106, etc.) can obtain output data from a generator trained in a MatAN. For example, vehicle computing system 106 can receive output data from map generation system 102, which was generated using the trained generator network, and/or generate output data by processing itself, using the trained generator network, input data including one or more other images. For example, map generation system 102 and/or vehicle computing system 106 can process, using an adversarial network model having a loss function that has been implemented based on a siamese discriminator network model, input data to determine output data. In some non-limiting embodiments or aspects, vehicle computing system 106 trains an adversarial network including a siamese discriminator network and the generator network.

In some non-limiting embodiments or aspects, vehicle computing system 106 controls travel and one or more functionalities associated with a fully autonomous mode of autonomous vehicle 104 during fully autonomous operation of autonomous vehicle 104 (e.g., controls a device that controls acceleration, controls a device that controls steering, controls a device that controls braking, controls an actuator that controls gas flow, etc.) based on the output data. For example, motion planning system 232 determines a motion plan that minimizes a cost function that is dependent on the output data. As an example, motion planning system 232 determines a motion plan that minimizes a cost function for controlling autonomous vehicle 104 on a driving path or a centerline path in the roadway extracted from the input data and/or with respect to one or more objects classified and/or identified in the input data.

In some non-limiting embodiments or aspects, an architecture of a generator network can include a residual network, such as a ResNet-50 based encoder (e.g., as disclosed by K. He, X. Zhang, S. Ren, and J. Sun in the paper titled “Deep residual learning for image recognition”, (CoRR, abs/1512.03385, 2015), the entire contents of which is hereby incorporated by reference), and a decoder containing transposed convolutions for upsampling and identity ResNet blocks as non-linearity (e.g., as disclosed by K. He, X. Zhang, S. Ren, and J. Sun in the paper titled “Identity mappings in deep residual networks”, (CoRR, abs/1603.05027, 2016), the entire contents of which is hereby incorporated by reference).

In some non-limiting embodiments or aspects, an output of a generator network may be half a size of an input to the generator network. For example, a 32×32 pixel or cell input size can be used for a discriminator network with 50% overlap of pixel or cell patches. In some non-limiting embodiments or aspects, Cityscapes results based on the CityScapes dataset as disclosed by M. Cordts, M. Omran, S. Ramos, T. Rehfeld, M. Enzweiler, R. Benenson, U. Franke, S. Roth, and B. Schiele in the paper titled “The cityscapes dataset for semantic urban scene understanding”, (In CVPR, 2016), the entire contents of which is hereby incorporated by reference, can be reported with a multi-scale discriminator network. In some non-limiting embodiments or aspects, ResNets may be applied without batch norm in a discriminator network.

In some non-limiting embodiments or aspects, an architecture of a generator network can include a U-net architecture, such as disclosed by P. Isola, J. Zhu, T. Zhou, and A. A. Efros in the paper titled “Image-to-image translation with conditional adversarial networks, (In CVPR, 2017), hereinafter “Isola et al.”, the entire contents of which is hereby incorporated by reference.

In some non-limiting embodiments or aspects, the Adam optimizer, as disclosed by D. P. Kingma and J. Ba. Adam in the paper titled “A method for stochastic optimization”, (CoRR, abs/1412.6980, 2014), the entire contents of which is hereby incorporated by reference, with 10⁻⁴ learning rate, a weight decay of 2*10⁻⁴, and batch size of four with dropout with a 0.9 keep probability in the generator network and to the feature vector d of the discriminator network may be used to train a MatAN. For example, generator and discriminator networks may be trained until convergence, which may use on the order of 10,000 iterations. As an example, each iteration (e.g., an update of parameters of the generator network and an update of parameters of the discriminator network, etc.) may take about four seconds on an NVIDIA Tesla P100 GPU. In such an example, the output to may be normalized to [−1, 1] by a tan h function if the output image has a single channel (e.g., a road center-line, etc.) or by a rescaled softmax function (e.g., for a segmentation task, etc.).

### Semantic Segmentation Examples

Pixel-wise cross-entropy is well aligned with pixel-wise intersection over union (IoU) and can be used as a task loss for semantic segmentation networks. In some non-limiting embodiments or aspects, a loss of a MatAN can achieve a similar or same performance as a cross entropy model. For example, an ablation study can be performed in which a generator network architecture is fixed (e.g., the ResNet based encoder-decoder, etc.), but the discriminator function can be changed. In such an example, an input image may be downsampled to 1024×512 pixels or cells, an official validation data set can be randomly split to half-half, with one half used for early stopping of the training and the other half used to compute validation or performance results or values, which can be repeated multiple times (e.g., three times, etc.) to determine a mean performance over the random splits of the official validation data set.

Table 1 below provides results of an ablation study for implementations (α), (β), (γ), (δ), (ε), and (ζ) of perturbation configurations for a MatAN according to some non-limiting embodiments or aspects on an example semantic segmentation task. In Table 1, mean intersection over union (mIoU) and pixel-wise accuracy (Pix. Acc) validation or performance results or values are based on a validation data set (e.g., the Cityscapes validation set, etc.) input to a ResNet generator. Each of the values in Table 1 are represented as a percentage value. The Greek letters (α), (β), (γ), (δ), (ε), and (ζ) indicate implementations (α), (β), (γ), (δ), (ε), and (ζ) of perturbation configurations for a MatAN according to some non-limiting embodiments or aspects. As shown in Table 1, for an example semantic segmentation task, a MatAN according to some non-limiting embodiments or aspects can achieve similar or same performance values as an existing cross entropy model (Cross Ent. in Table 1) and can achieve 200% higher performance values than the existing CGAN as described by Isola et al. As further shown in Table 1, when perturbations are applied to the ground truth, a MatAN according to some non-limiting embodiments or aspects can achieve considerably higher results than the existing CGAN as described by Isola et al. using a noisy ground truth and an existing cross-entropy model using perturbed ground truth.

TABLE 1

| | | |
|---|---|---|
| ResNet Gen. | mIoU | Pix. Acc |

Original Ground Truth:

| | | |
|---|---|---|
| Cross Ent. | 66.9 | 94.7 |
| MatAN α NoPer. | 6.0 | 58.1 |
| MatAN β NoAbs. | 21.3 | 77.5 |
| MatAN β | 63.3 | 94.1 |
| MatAN MS β | 66.8 | 94.5 |
| MatAN γ Match2Per. | 63.5 | 93.3 |
| MatAN δ PertGen. | 60.2 | 93.8 |
| MatAN β MS + Cross Ent. | 65.1 | 94.2 |

Perturbed Ground Truth:

| | | |
|---|---|---|
| Pert. GT | 44.8 | 78.0 |
| Pert. Cross Entropy | 42.7 | 85.1 |
| MatAN ϵ GT Perturb | 25.9 | 82.8 |
| MatAN ζ All Perturb | 58.1 | 93.8 |

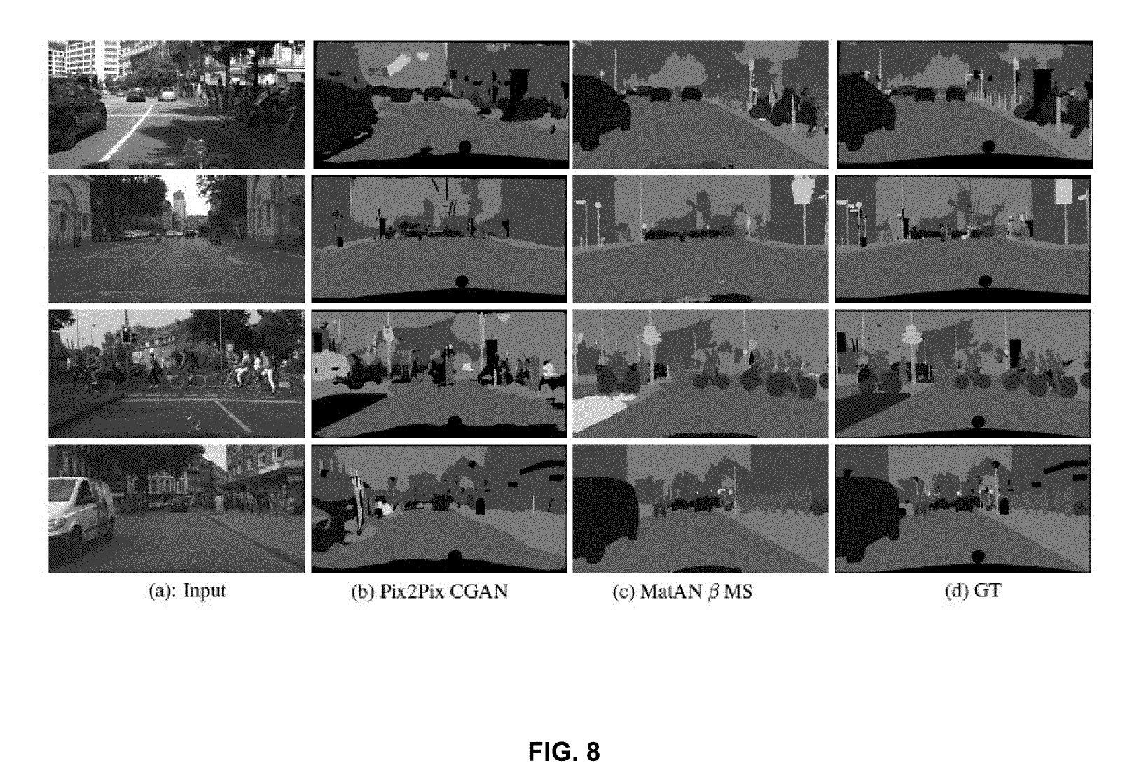

In an implementation of a perturbation configuration (α) where there is no perturbation (MatAN α NoPer.), the MatAN may not learn. Implementations of perturbation configurations (β) and (γ), in which generated output can be matched to ground truth or perturbations of the ground truth, may perform similarly. For example, implementations of each of the perturbation configurations (β) and (γ) can achieve equilibrium, if the ground truth is generated as output and not a perturbation. As an example, use of a single discriminator (e.g., not patch-wise, etc.) can enable learning the ground truth. In some non-limiting embodiments or aspects, use of a multi-scale discriminator network in an implementation of the perturbation configuration (β) (MatAN MS β) can achieve similar or same performance results as an existing cross-entropy model (e.g., by extracting patches, such as on scales 16, 32 and 64 pixels, and resizing the patches, such as to a scale of 16 pixels, etc.). For example, referring now to FIG. 8, FIG. 8 shows example segmentation outputs on: (a) a Cityscapes input for; (b) the existing Pix2Pix CGAN described by Isola et al.; (c) the implementation MatAN MS β; and (d) ground truth (GT). As shown in FIG. 8, the existing Pix2Pix CGAN captures larger objects with homogeneous texture, but hallucinates objects in the image. In contrast, the implementation MatAN MS β according to some non-limiting embodiments or aspects can produce a similar or same output to the ground truth.

Still referring to Table 1, an implementation of the perturbation configuration (β) (MatAN β NoAbs) shows that removing the l1 distance in Equation (2) for d may result in a relatively large performance decrease. An implementation of the perturbation configuration (β) (MatAN β MS+Cross Ent.) combined with the existing cross entropy loss model performs slightly worse than using each loss separately, which shows that fusing loss functions may not be trivial.

In an implementation of the perturbation configuration δ (MatAN δ PertGen.), the generated output is perturbed, which enables equilibrium to be achieved in any of the perturbations of the ground truth. For example, if overlap is not applied for the discriminator pixel patches, the performance results show that the network implementation MatAN δ PertGen can learn the original ground truth (e.g., instead of a perturbed ground truth, etc.), which can be explained by the patch-wise discriminator. As an example, an output satisfying each discriminator patch is likely to be similar or the same as the original ground truth. In such an example, a deterministic network prefers to output a straight line or boundary on an image edge rather than randomly rotated versions where a cut has to align with a patch boundary.

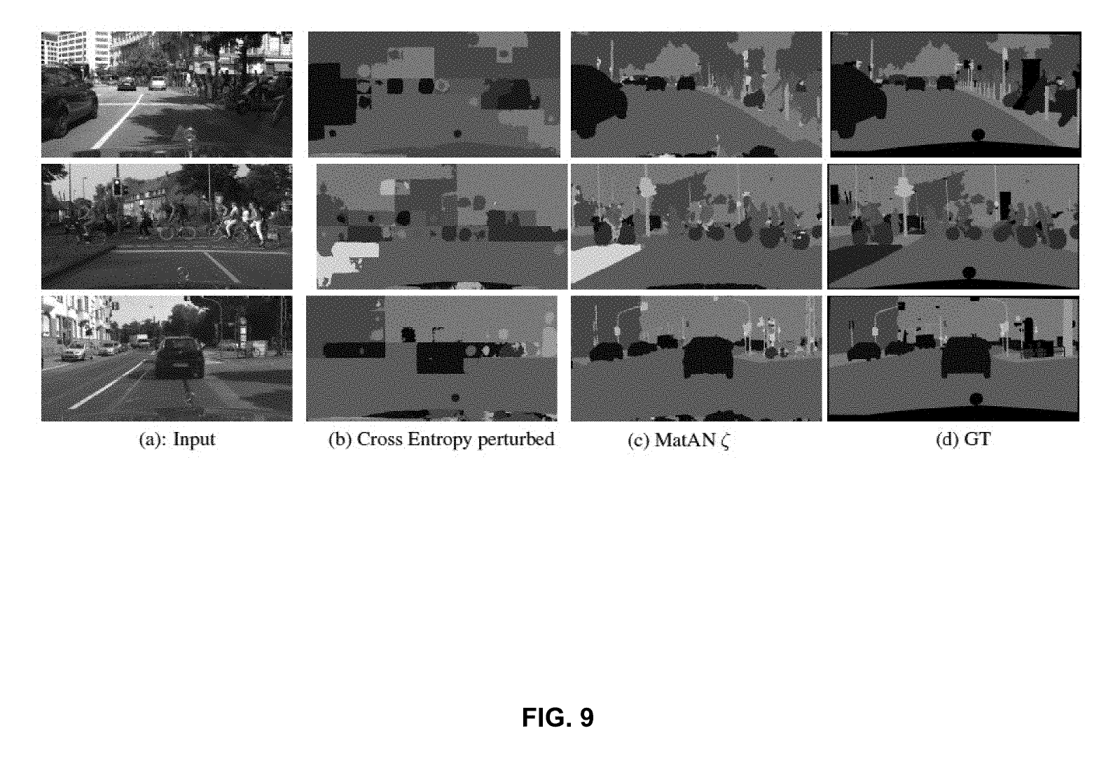

In some non-limiting embodiments or aspects, applying perturbations to each branch y₁, y₂ of the positive samples can be considered as a noisy ground truth (e.g. two labelers provide different output for similar image regions, etc.). For example, perturbations can simulate the different output for similar image regions with a known distribution of the noise. In Table 1, entry Pert. GT shows the mIoU of a perturbed ground truth compared to an original ground truth. When the existing cross entropy model is trained with these noisy labels (Pert. Cross Entropy), the Pert. Cross Entropy network loses the fine details and performs about the same as the perturbed ground truth. In an implementation of the perturbation configuration (ε) (MatAN ε GT Perturb), in which the generated output is not perturbed, equilibrium may not be achieved, which results in lower performance. In an implementation of the perturbation configuration (ζ) (MatAN ζ All Perturb), in which the generated output is perturbed, equilibrium can be achieved in any of the perturbed ground truths. For example, referring now to FIG. 9, FIG. 9 shows example segmentation outputs on: (a) a Cityscapes input for; (b) the Pert. Cross Entropy network; (c) the implementation MatAN ζ All Perturb; and (d) ground truth (GT). As shown in FIG. 9, because perturbations can be rotations applied patch-wise, a consistent solution for the entire image from the implementation MatAN ζ All Perturb is similar or the same as the ground truth. For example, the generator network in the implementation MatAN ζ All Perturb may be trained to infer a consistent solution. In such an example, the generator network in the implementation MatAN ζ All Perturb can learn to predict a continuous pole (e.g., as shown FIG. 9 at example (c)), although a continuous pole may not occur in perturbed training images. In contrast, as shown in FIG. 9 at example (b), the Pert. Cross Entropy network may only learn blobs.

Table 2 below shows a comparison to the existing Pix2Pix CGAN as described by Isola et al. to implementations of the perturbation configuration (β) in which the ResNet generator network is replaced with the U-net architecture of Pix2Pix. For example, Table 2 shows mIoU and pixel-wise accuracy results from three fold cross-validation on the Cityscapes validation data set with the U-Net generator architecture of Pix2Pix. Each of the values in Table 2 are represented as a percentage value. The indicator (*) marks results reported from third parties on the validation data set. Implementations of the perturbation configuration (β) in which the ResNet generator network is replaced with the U-net architecture of Pix2Pix in a MatAN according to some non-limiting embodiments or aspects (MatAN β MS and MatAN β Pix2Pix arch. MS) achieve much higher performance than existing Pix2Pix CGANs.

TABLE 2

| U-Net Gen | mIoU | Pix. Acc |
|---|---|---|
| Cross Ent. | 50.9 | 91.8 |
| Pix2Pix CGAN | 21.5 | 73.1 |
| Pix2Pix CGAN* | 22.0 | 74.0 |
| Pix2Pix CGAN + L1* | 29.0 | 83.0 |
| CycGAN* | 16.0 | 58.0 |
| MatAN β MS | 48.9 | 91.4 |
| MatAN β Pix2Pix arch. MS | 48.4 | 91.5 |

To show that the performance result increase is not simply caused by the ResNet blocks, a design of the discriminator network may be changed to match the Pix2Pix discriminator. For example, as shown in Table 2, changing the discriminator architecture to match the Pix2Pix discriminator achieves lower mIoU values, but still doubles the performance of the existing Pix2Pix CGANs and achieves performance results similar or the same as achieved by training the generator using cross-entropy loss, which indicates that a stability of the learned loss function may not be sensitive to the choice or type of generator architecture, and that a decrease in performance relative to ResNet-based models may be due to the reduced capability of the U-net architecture. As an example, the existing Pix2Pix CGAN as described by Isola et al. applied without the additional task loss achieves performance results far lower than the implementations MatAN β MS and MatAN β Pix2Pix arch. MS. For example, the existing Pix2Pix CGAN may only learn relatively larger objects which appear with relatively homogeneous texture (e.g., a road, sky, vegetation, a building, etc.). In such an example, the existing Pix2Pix CGAN as described by Isola et al. may also “hallucinate” objects into the image, which can indicate that the input-output relation is not captured properly with CGANs using no task loss. Further, even by adding L1, the existing Pix2Pix CGAN as described by Isola et al. is outperformed by the implementations MatAN β MS and MatAN β Pix2Pix arch. MS. A cycle-consistent adversarial network (CycleGAN) as described by J.-Y. Zhu, T. Park, P. Isola, and A. A. Efros in the paper titled “Unpaired image-to-image translation using cycle-consistent adversarial networks”, (In ICCV, 2017), the entire contents of which is hereby incorporated by reference, provides even lower performance results than the existing Pix2Pix CGAN.

### Road Centerline Extraction Examples

In some non-limiting embodiments or aspects, roads are represented by centerlines of the roads as vectors in a map. For example, the TorontoCity dataset as described by S. Wang, M. Bai, G. Mattyus, H. Chu, W. Luo, B. Yang, J. Liang, J. Cheverie, S. Fidler, and R. Urtasun in the paper titled “Torontocity: Seeing the world with a million eyes” (In ICCV, 2017), the entire contents of which is hereby incorporated by reference, includes aerial images of geographic locations in the city of Toronto. As an example, the aerial images of the TorontoCity dataset can be resized to 20 cm/pixel, a one channel image generation with [−1, 1] values can be used, and the vector data can be rasterized according to the image generation as six pixel wide lines to serve as training samples. In such an example, circles can be added at intersections in the aerial images to avoid the generation of sharp edges for the intersections, which may be difficult for neural networks.

Table 3 below shows metrics expressing a quality of road topology in percentages of an implementation of the perturbation configuration (β) (MatAN) as compared to other existing road centerline extraction methods. For example, the implementation of the perturbation configuration (β) (MatAN) is compared to a HED deepnet based edge detector as disclosed by S. Xie and Z. Tu in the paper titled “Holistically-nested edge detection”, (In ICCV, 2015), the entire contents of which is hereby incorporated by reference, and a DeepRoadMapper as disclosed by G. Mattyus, W. Luo, and R. Urtasun in the paper titled “Deeproadmapper: Extracting road topology from aerial images”, (In ICCV, 2017), the entire contents of which is hereby incorporated by reference, and which extracts the road centerlines from the segmentation mask of the roads and reasons about graph connectivity. Semantic segmentation followed by thinning as a baseline with a same generator network as in a MatAN according to some non-limiting embodiments or aspects may be used. For example, two variants, (i) Seg3+thinning which exploits extra three class labeling (e.g., background, road, buildings, etc.) for semantic segmentation, and (ii) Seg2+thinning which exploits two labels instead (e.g., background, road, etc.) are used for comparison to the implementation of the perturbation configuration (β) (MatAN). OpenStreetMap (OSM) is also used as a human baseline. The existing CGANs as described by Isola et al. that use the adversarial loss (CGAN) and the adversarial loss combined with L1 (CGAN+L1) are also provided for comparison in Table 3. For example, training a generator architecture with the CGAN loss as described by Isola et al. may not generate reasonable outputs even after 15 k iterations, which shows that CGANs are sensitive to the network architecture.

In Table 3, Road topology recovery metrics are represented in percentage values. The metric (Seg.) indicates if the method uses extra semantic segmentation labeling (e.g., background, road, building, etc.). The reference (*) indicates that the results are from external sources.

TABLE 3

| | | Validation set | | | | Test set | | | |
|---|---|---|---|---|---|---|---|---|---|
| Method | Seg. | F1 | Precision | Recall | CRR | F1 | Precision | Recall | CRR |
| OSM (human) * | — | — | — | — | — | 89.7 | 93.7 | 86.0 | 85.4 |
| DeepRoadMapper * | ✓ | — | — | — | — | 84.0 | 84.5 | 83.4 | 77.8 |
| Seg3+thinning | ✓ | 91.7 | 96.0 | 87.8 | 87.8 | 91.0 | 93.6 | 88.4 | 88.0 |
| HED * | — | — | — | — | — | 42.4 | 27.3 | 94.9 | 91.2 |
| Seg2+thinning | — | 89.7 | 94.9 | 85.1 | 82.5 | 88.4 | 92.7 | 84.5 | 78.0 |
| CGAN | — | 75.7 | 76.4 | 74.9 | 75.1 | 77.0 | 67.65 | 89.7 | 81.8 |
| CGAN + L1 | — | 78.5 | 95.1 | 66.8 | 68.9 | 68.6 | 93.3 | 54.3 | 55.0 |
| MatAN | — | 92.5 | 95.7 | 89.5 | 88.1 | 90.4 | 91.4 | 89.5 | 87.1 |

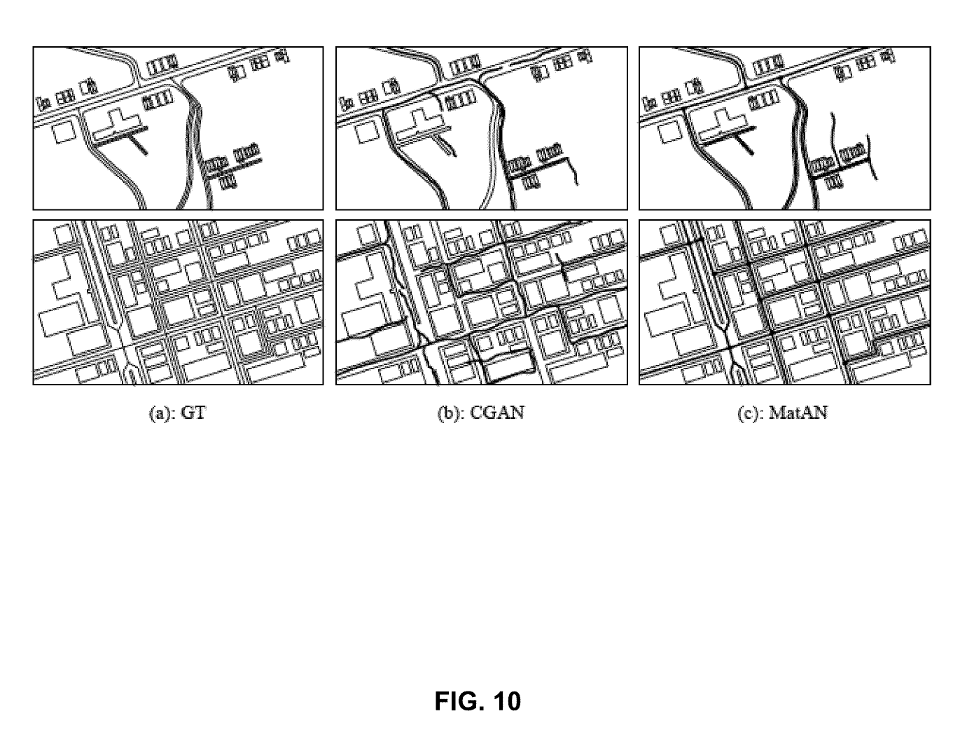

As shown in Table 3, the two highest performance results are achieved by the implementation MatAN and the DeepRoadMapper using Seg3+thinning, which exploits additional labels (e.g., semantic segmentation, etc.). Without this extra labeling, the segmentation based method HED Seg2 and the DeepRoadMapper fall behind the implementation MatAN with respect to the performance results. The existing Pix2Pix CGAN as described by Isola et al. generates road like objects, but the generated objects are not aligned with the input image resulting in worse performance results. OSM achieves similar numbers to automatic methods, which shows that mapping roads is not an easy task, because it may be ambiguous as to what counts as road. For example, referring now to FIG. 10, FIG. 10 shows output of a road centerline line extraction on example aerial images of the TorontoCity data set for: (a) ground truth (GT); (b) the existing CGAN as described by Isola et al.; and (c) the implementation MatAN. As shown in FIG. 10, the implementation MatAN according to some non-limiting embodiments or aspects can capture the topology for parallel roads.

### Instance Segmentation Examples

In Table 4 below, performance results of instance segmentation tasks for predicting building instances in the TorontoCity data validation set using the metrics as described with respect to the TorontoCity data validation set are provided. Each of the metrics in Table 4 are represented as a percentage value. The metric (WCov.) represents weighted coverage, the metric (mAP) represents mean precision, the metric (R. @ 50%) represents recall at 50%, and the metric (Pr. @ 50%) represents precision at 50%. The reference (*) indicates results from external sources. The performance results in Table 4 are based on aerial images resized to 20 cm/pixel. For example, images with size 768×768 pixels can be randomly cropped, rotated, and flipped, and used a batch size of four. The three class semantic segmentation can be jointly generated and the instance contours as a binary image ([−1, 1]).

TABLE 4

| Method | mAP | Pr. @50% | R. @ 50% | WCov. |
|---|---|---|---|---|
| ResNet* | 22.4 | 44.6 | 18.0 | 38.1 |
| FCN* | 16.0 | 35.1 | 20.3 | 38.9 |
| DWT* | 43.4 | 75.1 | 76.8 | 64.4 |
| MatAN | 42.2 | 82.6 | 75.9 | 64.1 |

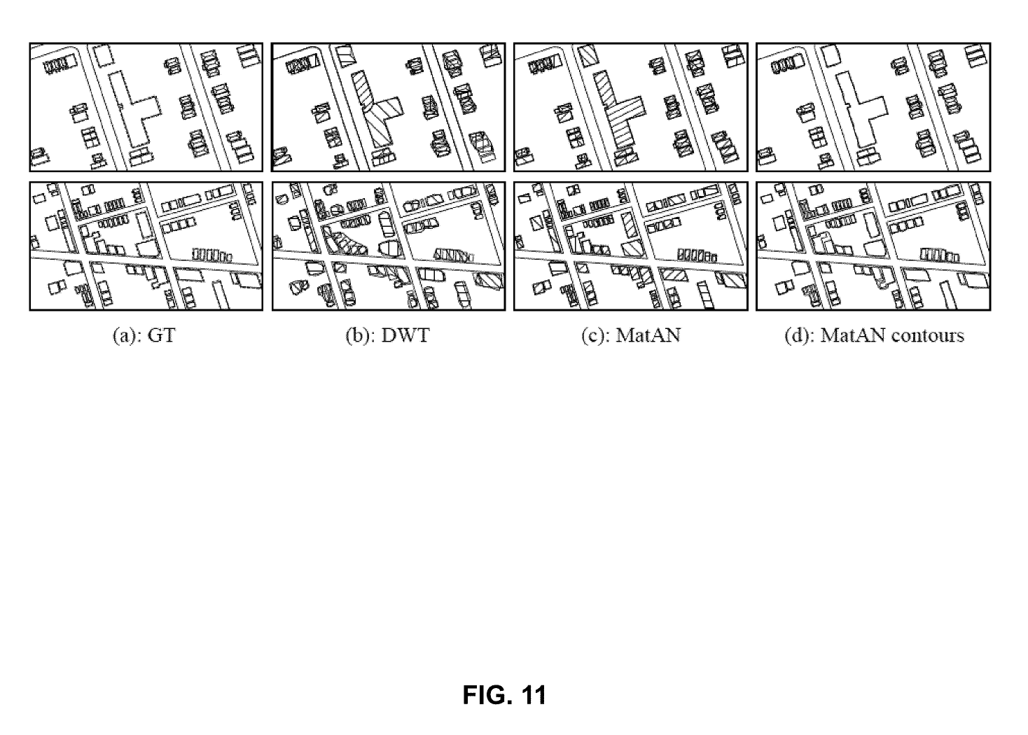

As shown in Table 4, an implementation of the perturbation configuration (6) (MatAN) can be trained as a single MatAN, which shows that a MatAN according to some non-limiting embodiments or aspects can be used as a single loss for a multi-task network. Instances from the connected components can be obtained as a result of subtracting the skeleton of the contour image from the semantic segmentation. The results are compared with baseline methods as disclosed in the paper describing the TorontoCity dataset and DeepWatershed Transform (DWT) (e.g., as described by M. Bai and R. Urtasun in the paper titled “Deep watershed transform for instance segmentation, (In CVPR, 2017), the entire contents of which are incorporated herein by reference, and which discloses predicting instance boundaries. As shown in Table 4, the implementation MatAN outperforms DWT by 7% in Precision @ 50%, while being similar with respect to the other metrics. For example, referring now to FIG. 11, FIG. 11 shows, for example, aerial images of: (a) Ground truth building polygons overlaying over the original image; (b) final extracted instances, each with a different color, for the DWT; (c) final extracted instances, each with a different color, for the implementation of the MatAN; and (d) a prediction of the MatAN for the building contours which is used to predict the instances. The ground truth of this task may have a small systemic error due to image parallax. In contrast to DWT, the implementation of the MatAN does not overfit on this noise.

Accordingly, a MatAN according to some non-limiting embodiments or aspects can include a siamese discriminator network that takes random perturbations of the ground truth as input for training, which as described herein, significantly outperforms existing CGANs, achieves similar or even superior results to task specific loss functions, results in more stable training.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, many of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method comprising:
obtaining, with a computing system comprising one or more processors, training data including one or more images and one or more ground truth labels of the one or more images; and
training, with the computing system, an adversarial network including a siamese discriminator network and a generator network by:
generating, with the generator network, one or more generated images based on the one or more images;
processing, with the siamese discriminator network, at least one pair of images including: (i) a ground truth label of the one or more ground truth labels of the one or more images; and (ii) one of: (a) a generated image of the one or more generated images generated by the generator network; and (b) a perturbed image of the ground truth label of the one or more ground truth labels of the one or more images, to determine a prediction of whether the at least one pair of images includes the one or more generated images; and
modifying, using a loss function of the adversarial network that depends on the ground truth label and the prediction, one or more parameters of the generator network.

2. The computer-implemented method of claim 1, wherein training, with the computing system, the adversarial network comprises:
modifying, using the loss function of the adversarial network that depends on the ground truth label and the prediction, one or more parameters of the siamese discriminator network.

3. The computer-implemented method of claim 2, wherein training, with the computing system, the adversarial network comprises:
iteratively alternating between: (i) modifying the one or more parameters of the generator network to optimize the loss function of the adversarial network with respect to the one or more parameters of the generator network; and (ii) modifying the one or more parameters of the siamese discriminator network to optimize the loss function of the adversarial network with respect to the one or more parameters of the siamese discriminator network.

4. The computer-implemented method of claim 1, further comprising:
applying, with the computing system, a perturbation to the generated image of the one or more generated images generated by the generator network.

5. The computer-implemented method of claim 1, wherein processing, with the siamese discriminator network, the at least one pair of images comprises:
receiving, with a first branch of the siamese discriminator network, as a first siamese input the ground truth label of the one or more ground truth labels of the one or more images;
receiving, with a second branch of the siamese discriminator network, as a second siamese input the one of: (a) the generated image of the one or more generated images generated by the generator network; and (b) the perturbed image of the ground truth label of the one or more ground truth labels of the one or more images;
applying, with the first branch of the siamese discriminator network, a first complex multi-layer non-linear transformation to the first siamese input to map the first siamese input to a first feature vector;
applying, with the second branch of the siamese discriminator network, a second complex multi-layer non-linear transformation to the second siamese input to map the second siamese input to a second feature vector; and
combining the first feature vector and the second feature vector in a combined feature vector, wherein the prediction of whether the at least one pair of images includes the one or more generated images is determined based on the combined feature vector.

6. The computer-implemented method of claim 1, further comprising:
providing, with the computing system, the generator network including the one or more parameters that have been modified based on the loss function of the adversarial network that depends on the ground truth label and the prediction;
obtaining, with the computing system, input data including one or more other images; and
processing, with the computing system and using the generator network, the input data to generate output data.

7. The computer-implemented method of claim 6, wherein the one or more other images include an image of a geographic region having a roadway, and wherein the output data includes feature data representing an extracted centerline of the roadway.

8. The computer-implemented method of claim 6, wherein the one or more other images include an image having one or more objects, and wherein the output data includes classification data representing a classification of each of the one or more objects within a plurality of predetermined classifications.

9. The computer-implemented method of claim 6, wherein the one or more other images include an image having one or more objects, and wherein the output data includes identification data representing an identification of the one or more objects.

10. The computer-implemented method of claim 6, wherein the computing system is on-board an autonomous vehicle.

11. A computing system comprising:
one or more processors programmed and/or configured to:
obtain training data including one or more images and one or more ground truth labels of the one or more images; and
train an adversarial network including a siamese discriminator network and a generator network by:
generating, with the generator network, one or more generated images based on the one or more images;
processing, with the siamese discriminator network, at least one pair of images including: (i) a ground truth label of the one or more ground truth labels of the one or more images; and (ii) one of: (a) a generated image of the one or more generated images generated by the generator network; and (b) a perturbed image of the ground truth label of the one or more ground truth labels of the one or more images, to determine a prediction of whether the at least one pair of images includes the one or more generated images; and
modifying, using a loss function of the adversarial network that depends on the ground truth label and the prediction, one or more parameters of the generator network.

12. The computing system of claim 11, wherein the one or more processors are programmed and/or configured to train the adversarial network by:
modifying, using the loss function of the adversarial network that depends on the ground truth label and the prediction, one or more parameters of the siamese discriminator network.

13. The computing system of claim 12, wherein the one or more processors are programmed and/or configured to train the adversarial network by:
iteratively alternating between: (i) modifying the one or more parameters of the generator network to optimize the loss function of the adversarial network with respect to the one or more parameters of the generator network; and (ii) modifying the one or more parameters of the siamese discriminator network to optimize the loss function of the adversarial network with respect to the one or more parameters of the siamese discriminator network.

14. The computing system of claim 11, wherein the one or more processors are further programmed and/or configured to:
apply a perturbation to the generated image of the one or more generated images generated by the generator network.

15. The computing system of claim 11, wherein processing, with the siamese discriminator network, the at least one pair of images comprises:
receiving, with a first branch of the siamese discriminator network, as a first siamese input the ground truth label of the one or more ground truth labels of the one or more images;
receiving, with a second branch of the siamese discriminator network, as a second siamese input the one of: (a) the generated image of the one or more generated images generated by the generator network; and (b) the perturbed image of the ground truth label of the one or more ground truth labels of the one or more images;
applying, with the first branch of the siamese discriminator network, a first complex multi-layer non-linear transformation to the first siamese input to map the first siamese input to a first feature vector;
applying, with the second branch of the siamese discriminator network, a second complex multi-layer non-linear transformation to the second siamese input to map the second siamese input to a second feature vector; and
combining the first feature vector and the second feature vector in a combined feature vector, wherein the prediction of whether the at least one pair of images includes the one or more generated images is determined based on the combined feature vector.

16. The computing system of claim 11, wherein the one or more processors are further programmed and/or configured to:
provide the generator network including the one or more parameters that have been modified based on the loss function of the adversarial network that depends on the ground truth label and the prediction;
obtain input data including one or more other images; and
process, using the generator network, the input data to generate output data.

17. The computing system of claim 16, wherein the one or more other images include an image of a geographic region having a roadway, and wherein the output data includes feature data representing an extracted centerline of the roadway.

18. The computing system of claim 16, wherein the one or more other images include an image having one or more objects, and wherein the output data includes classification data representing a classification of each of the one or more objects within a plurality of predetermined classifications.

19. The computing system of claim 16, wherein the one or more other images include an image having one or more objects, and wherein the output data includes identification data representing an identification of the one or more objects.

20. The computing system of claim 16, wherein the one or more processors are on-board an autonomous vehicle.
